(19) United States
(12) Patent Application Publication
(10) Pub. No.: US 2004/0120730 A1
(43) Pub. Date: Jun. 24, 2004

(54) Electrophotographic apparatus, process cartridge for electrophotographic apparatus, and image forming method

(76) Inventors: Tatsuya Niimi, Shizuoka (JP); Naohiro Toda, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/656,280

(22) Filed: Sep. 8, 2003

(30) Foreign Application Priority Data
Sep. 10, 2002 (JP) 2002-263941

(51) Int. Cl. G03G 5/047

(52) U.S. Cl. 399/159; 430/59.5; 430/59.6; 430/66

(57) ABSTRACT

The present invention relates to the electrophotographic apparatus wherein the photoconductor takes 200 msec or less to reach from the light irradiator to the developer, an exposure energy upon irradiation of a write light having a resolution of 600 dpi or greater from the light irradiator to the photoconductor is 5 erg/cm² or less on the surface thereof, the photoconductor is obtained by stacking a charge generation layer and a charge transport layer in this order on a conductive support, and the charge generation layer contains titanyl phthalocyanine crystals having, as a diffraction peak (±0.2°) of Bragg angle 2θ relative to CuKα ray (wavelength: 1.542 angstrom), a maximum diffraction peak at least at 27.2°, main peaks at 9.4°, 9.6° and 24.0°, and a peak at 7.3° as a diffraction peak on the lowest angle side, and not having a peak within a range of 7.4 to 9.3°.

### BACKGROUND OF THE INVENTION

1. Field of the Invention

The present invention relates to an electrophotographic apparatus using an electrophotographic photoconductor which is exposed to a light having a predetermined light amount or less to write an image, and is obtained by stacking at least a charge generation layer containing specific titanyl phthalocyanine crystals and a charge transport layer in this order; a process cartridge for the electrophotographic apparatus; and an image forming method.

2. Description of the Related Art

In recent years, an information processing system equipment using an electrophotographic system has achieved a remarkable development. In particular, an optical printer which converts information into digital signals and carries out information recording via a light has exhibited a markedly improvement in its print quality and reliability. This digital recording technique has been applied not only to printers but also conventional copying machines and so-called digital copiers have been developed. Copiers equipped with this digital recording technique in combination with the conventional analogue copying technique are presumed to show an increasing demand in future, because various information processing functions can be added thereto. In addition, with the popularization of personal computers and improvement in performance, digital color printers for outputting images and documents in color have made a rapid progress.

For such a digital-system electrophotographic apparatus, light sources of high output such as LD and LED have been employed as a writing light source. Such light sources enable high output, but their output and lifetime or their output and stability are contrary each other. Accordingly, in order to maintain long lifetime and high stability of the device even after repeated use of the electrophotographic apparatus, it is desired to use the apparatus while maintaining the output as low as possible.

Recently, there has been a demand for size reduction and speed up of the apparatus simultaneously. With regards to its size, the smallest size of the apparatus is a size which allows outputting of A3, and the diameter of a photoconductor is decreased therefor. A monochrome electrophotographic apparatus needs only one photoconductor so that a photoconductor having a diameter of about 100 mm is usable at the maximum. As a full-color electrophotographic apparatus, on the other hand, a tandem type one featuring high speed printing is most popularly used. Since the tandem type full-color electrophotographic apparatus has a plurality of image forming elements installed thereon, a further decrease in the diameter of the photoconductor is essential. In most cases, a photoconductor having a diameter of 30 mm is used.

With regards to the speedup of a monochrome electrophotographic apparatus, a copying (printing) speed of 60 sheets/min or greater (100 sheets/min at the maximum) has become prevalent. Members (charger, light irradiator, developer, and transfer, and if necessary, cleaner and charge eliminator) at least necessary for electrophotographic process are disposed around the photoconductor and in addition, another member for heightening durability may be used in combination, which considerably narrows the space around the photoconductor. Even if a photoconductor having a diameter of 100 mm is used as described above, time from a writing portion to a development portion becomes increasingly short, because a distance between the exposure and development cannot be increased so much and a linear velocity of the photoconductor is rapid. The time is about 200 msec at the longest.

In the tandem full-color electrophotographic apparatus, on the other hand, a small-diameter photoconductor as described above is used and a copying (printing) speed reaches 30 sheets/min or greater as a result of development. Under such situations, even if the structure around the photoconductor is simplified as much as possible, the time between exposure and development can be set only equal to or less than that of the monochrome electrophotographic apparatus.

A further increase in copying or printing speed of business documents is presumed to be promoted in future and for this purpose, attainment of a high-speed response (sufficient light attenuation and carrier shift) in a short time will be an important key.

For high-speed response in a short time, a higher gain (greater potential attenuation) and a higher response (more prompt potential attenuation) of a photoconductor are necessary. The former one depends on the development of a charge generation substance having a large quantum efficiency, while the latter one depends on the development of a charge transport substance having a large mobility.

Since a charge generation substance having a large quantum efficiency is usually a compound having a high chemical reactivity, repeated use of it in an electrophotographic apparatus tends to impair the stability of its properties.

With regards to an improvement in mobility, owing to the development of a low molecular charge transport substance exhibiting high transport properties and development of a molecular dispersed polymer, use of a low molecular charge transport substance at a relatively high concentration enables attainment of the mobility in the former half of the order of 10⁻⁵ (cm²/V·sec). It has therefore become possible to respond to a process in which the time from a writing portion to a development portion is less than 100 msec when calculated based on the mobility, unless the charge transport layer is excessively thick. It is however an obvious fact that when writing is conducted using LD or LED, reciprocity failure occurs in the carrier generation of a photoconductor. This owes to not a sufficiently high light carrier efficiency of a charge generation substance, but owes to the fact that because of irradiation of an excessive light amount to a photoconductor, a charge generation substance under a light excited state is deactivated into a ground state prior to conversion into a light carrier; or in spite of generation of light carriers, carrier recombination occurs prior to injection of carriers in the charge generation layer.

In practice, it is not impossible to increase an apparent gain amount (potential attenuation amount) of a photoconductor by irradiating a large light amount to a photoconductor having a small quantum efficiency. When a certain dot or line is written under such conditions, a “line or dot thickening” phenomenon inevitably occurs. In an electrophotographic process at a resolution less than 600 dpi, this phenomenon did not draw attentions, but with a recent reduction in the beam diameter in order to improve resolution, such a problems has appeared eminently. In practice, an electrophotographic apparatus which is an object of the present application has a resolution of a writing light of 600 dpi or greater.

With the foregoing facts in view, it is important to suppress (lower) the output from a device of an electrophotographic apparatus as much as possible in order to prevent a deterioration or instability of a write device. Simultaneously, suppression of the output is effective for precise reproduction of minute dots. Charge generation substances so far developed rarely exhibit a high gain in a short time of 200 msec or less as a time between exposure-development and exhibit this function stably even after repeated use. In an electrophotographic apparatus having an exposure-development time of 200 msec or less, it is therefore very difficult to lower an exposure energy (5 erg/cm² or less) of a light irradiated to a photoconductor.

As a material capable of exhibiting such a high gain, titanyl phthalocyanine crystals having at least a maximum diffraction peak at least at 27.2° as a diffraction peak (+0.2°) of Bragg angle 2θ with respect to CuKα ray (wavelength: 1.542 angstrom) are known. This crystal type involves such a problem that because of a low stability as a crystal, crystal transfer tends to occur by a mechanical stress, for example, of a disperser or a thermal stress. The sensitivity of the crystal type after crystal transfer is very low compared with that before crystal transfer. Sufficient light carrier generation mechanism cannot be exhibited fully when crystal transfer occurs partially. Another problem is that electrostatic property tends to lower when the photoconductor is used in repetition.

It is possible to overcome such problems by changing the layout of the electrophotographic apparatus to increase the exposure-development distance, lowering the linear velocity of the photoconductor or enlarging the diameter of the photoconductor. The first method needs a drastic design change of the machine and is therefore not realistic. The second method reduces a copying (printing) speed, which disturbs speedup of the device. The third method inevitably enlarges the apparatus itself, making the apparatus to run counter to the main trend of speedup and size reduction.

The charge transport layer having a charge transport function is composed mainly of the above-described charge transport substance and a binder resin. It is the common practice to form the layer by dissolving or dispersing these materials in a solvent and applying the resulting coating solution. As the solvent, halogen solvents such as dichloromethane and chloroform tend to be used because they exhibit excellent solubility and coating properties.

With the growing awareness of environmental problems, there has recently been a demand for the development of a photoconductor manufactured using a non-halogen solvent having a smaller burden on human bodies or environment. When a photoconductor is manufactured by employing a charge transport layer coating solution prepared using a non-halogen solvent, problems such as reduction in light attenuation properties in a low electric field and an increase in residual potential occur. Particularly, such a phenomenon is marked at present in titanyl phthalocyanine having a predetermined crystal type (a crystal type having a maximum diffraction peak at at least 27.2° as a diffraction peak (+0.2°) of Bragg angle 2θ with relative to CuKα ray (wavelength 1.542 angstrom)) exhibiting exceptionally high sensitivity to a wavelength range (600 to 780 nm) permitting LD or LED to show a relatively stable oscillation output. This charge generation substance therefore cannot exhibit its original properties fully and it has become a serious problem.

Various investigations have been carried out as a method of using a non-halogen solvent. For example, proposed is a method of using a dioxolane compound as an organic solvent free of a halogen (for example, Japanese Patent Application Laid-Open (JP-A) No. 10-326023 (claims 1, 2, and 5; page 3, left column, lines 4 to 11; page 3, left column, lines 15 to 25; and page 3, left column, lines 34 to 41)). As another method, proposed is a method of adding a specific antioxidant or ultraviolet absorber to a cyclic ether solvent such as tetrahydrofuran (refer to, for example, Japanese Patent Application Laid-Open (JP-A) No. 2001-356506 (claim 1, page 3, right column, lines 13 to 40), and Japanese Patent Application Laid-Open (JP-A) No. 04-191745 (claim 1, page 2, upper right column, lines 11 to 18)). These methods are however not satisfactory, because their effects against the above-described defects are insufficient or additives adversely affect and cause a deterioration in the sensitivity.

Accordingly, there is a demand for completion of an electrophotographic photoconductor exhibiting good light attenuation properties even if titanyl phthalocyanine having a peculiar high sensitivity is used as a charge generation substance and a non-halogen solvent is used for a charge transport layer coating solution; and electrophotographic apparatus and electrophotographic process cartridge, each using the above-described photoconductor.

### SUMMARY OF THE INVENTION

An object of the present invention is to provide an electrophotographic apparatus capable of satisfying the demand for highly fine and high speed image output, and outputting stable images free of line thickening even after repeated use at high speed; a process cartridge for the electrophotographic apparatus; and an image forming method capable of satisfying the demand for highly fine and high-speed image output, and outputting stable images free of line thickening even after repeated use at high speed.

More specifically, an object of the present invention is to provide an electrophotographic apparatus capable of overcoming a deterioration or instability of a light source and at the same time having a photoconductor whose surface potential (exposed portion, unexposed portion) is highly stable even by writing at a resolution of 600 dpi or greater. Another object is to provide an electrophotographic apparatus capable of maintaining a high sensitivity which is inherent to titanyl phthalocyanine even if a non-halogen solvent is used for a charge transport layer coating solution.

The present inventors have carried out an extensive investigation on the using method of a high-speed digital electrophotographic apparatus in which the reliability of a light source is taken into consideration, and on the setting of a photoconductor most suited to the method, and completed the present invention.

In one aspect of the present invention, there is thus provided an electrophotographic apparatus comprising:

an electrophotographic photoconductor;

a charger for charging the electrophotographic photoconductor;

a light irradiator for irradiating a white light to the electrophotographic photoconductor charged by the charger, thereby forming a latent electrostatic image;

a developer for feeding a developing agent to the latent electrostatic image, thereby visualizing the latent electrostatic image to form a toner image; and

a transfer for transferring the toner image formed by the developer onto a transfer material; wherein:

a surface of the electrophotographic photoconductor exposed by the light irradiator requires 200 msec or less to reach the developer,

an exposure energy when the write light having a resolution of 600 dpi or greater is irradiated from the light irradiator to the electrophotographic photoconductor is 5 erg/cm² or less on the surface thereof,

the electrophotographic photoconductor is obtained by stacking at least a charge generation layer and a charge transport layer in this order on a conductive support, and

the charge generation layer contains titanyl phthalocyanine crystals having, as a diffraction peak (±0.2°) of Bragg angle 2θ with respect to CuKα ray (wavelength: 1.542 angstrom), a maximum diffraction peak at least at 27.2°, main peaks at 9.4°, 9.6° and 24.0°, and a peak at 7.3° as a diffraction peak on the lowest angle side, and not having a peak within a range of from 7.4 to 9.3°.

The titanyl phthalocyanine crystals preferably have not a peak at 26.3°.

The titanyl phthalocyanine crystals preferably have an average primary particle diameter less than 0.3 μm.

The charge transport layer preferably contains at least a polycarbonate having, on the main chain and/or side chain thereof, a triarylamine structure.

The charge transport layer has preferably a protective layer thereon.

The protective layer can contain one of an inorganic pigment and a metal oxide having a specific resistance of 10¹⁰ Ω·cm or greater.

The charge transport layer of the electrophotographic photoconductor has been formed using a non-halogen solvent.

At least one solvent selected from cyclic ethers and aromatic hydrocarbons is preferably used as the non-halogen solvent.

The conductive support of the electrophotographic photoconductor has preferably an anodized surface.

In the electrophotographic apparatus of the present invention, a plurality of image forming elements each having at least a charger, a light irradiator, a developer, a transfer and an electrophotographic photoconductor have been arranged.

As the charger of the electrophotographic apparatus, either one of a contact charging system or a non-contact proximal charging system can be employed.

A gap between a charging member used for the charger and the electrophotographic photoconductor is preferably 200 μm or less.

Alternating superposed voltage is preferably applied to the charger of the electrophotographic apparatus.

The electrophotographic apparatus may have, installed thereon, a freely detachable process cartridge in which an electrophotographic photoconductor has been formed integral with at least one unit selected from a charger, light irradiator, developer and cleaner.

In a second aspect of the present invention, there is thus provided a process cartridge used as a detachable member and formed integral with an electrophotographic apparatus comprising:

an electrophotographic photoconductor;

a charger for charging the electrophotographic photoconductor;

a light irradiator for irradiating a white light to the electrophotographic photoconductor charged by the charger in an image pattern, thereby forming a latent electrostatic image;

a developer for feeding a developing agent to the latent electrostatic image, thereby visualizing the latent electrostatic image to form a toner image; and

a transfer for transferring the toner image formed by the developer onto a transfer material, wherein a surface of the electrophotographic photoconductor exposed by the light irradiator requires 200 msec or less to reach the developer, and an exposure energy when the write light having a resolution of 600 dpi or greater is irradiated from the light irradiator to the electrophotographic photoconductor is 5 erg/cm² or less on the surface thereof, which process cartridge comprises:

an electrophotographic photoconductor and at least one unit selected from a charger, a light irradiator, a developer and a cleaner, said electrophotographic photoconductor being obtained by stacking at least a charge generation layer and a charge transport layer in this order on a conductive support, and containing, in the charge generation layer, titanyl phthalocyanine crystals having, as a diffraction peak (±0.2°) of Bragg angle 2θ with respect to CuKα ray (wavelength: 1.542 angstrom), a maximum diffraction peak at least at 27.2°, main peaks at 9.4°, 9.6° and 24.0°, and a peak at 7.3° as a diffraction peak on the lowest angle side, and not having a peak within a range of from 7.4 to 9.3°.

In a third aspect of the present invention, there is thus provided an image forming method comprising:

charging an electrophotographic photoconductor, exposing the electrophotographic photoconductor charged by the charger in an image pattern, thereby forming a latent electrostatic image, developing by feeding a developing agent to the latent electrostatic image to visualize the latent electrostatic image into a toner image, and transferring the toner image formed in the developing step onto a transfer material, wherein:

a surface of the electrophotographic photoconductor exposed in the exposing step requires 200 msec or less to reach the developing step,

a write light having a resolution of 600 dpi or greater is irradiated from a light irradiator to the electrophotographic photoconductor so that an exposure energy will become 5 erg/cm² or less on the surface thereof in the exposing step,

said electrophotographic photoconductor is obtained by stacking at least a charge generation layer and a charge transport layer in this order on a conductive support, and

said charge generation layer contains titanyl phthalocyanine crystals having, as a diffraction peak (±0.2°) of Bragg angle 2θ with respect to CuKα ray (wavelength: 1.542 angstrom), a maximum diffraction peak at least at 27.2°, main peaks at 9.4°, 9.6° and 24.0°, and a peak at 7.3° as a diffraction peak on the lowest angle side, and not having a peak within a range of from 7.4 to 9.3°.

### BRIEF DESCRIPTION OF THE DRAWING

FIG. 1 is a diagram for explaining the electrophotographic process and electrophotographic apparatus of the present invention;

FIG. 2 illustrates one example of a proximal charging mechanism having, disposed on the charging member side thereof, a gap forming member;

FIG. 3 illustrates an example of the electrophotographic process of the present invention;

FIG. 4 is a diagram illustrating one conventional example of the shape of a process cartridge;

FIG. 5 is a schematic view for explaining a tandem full-color electrophotographic apparatus of the present invention;

FIG. 6 is a diagram showing light attenuation properties of a photoconductor using conventional titanyl phthalocyanine crystals and a photoconductor of the present invention using specific titanyl phthalocyanine;

FIG. 7 is a cross-sectional view illustrating a constitution example of the electrophotographic photoconductor used in the present invention;

FIG. 8 is a cross-sectional view illustrating another constitution example of the electrophotographic photoconductor used in the present invention;

FIG. 9 illustrates an X-ray diffraction spectrum of titanyl phthalocyanine crystals obtained in Synthesis Example 1;

FIG. 10 illustrates an X-ray diffraction spectrum of titanyl phthalocyanine crystals obtained in Synthesis Example 9;

FIG. 11 illustrates an X-ray diffraction spectrum of titanyl phthalocyanine crystals obtained in Measurement Example 1;

FIG. 12 illustrates an X-ray diffraction spectrum of titanyl phthalocyanine crystals obtained in Measurement Example 2; and

FIG. 13 illustrates one example of an image forming process cartridge of the present invention.

### DESCRIPTION OF THE PREFERRED EMBODIMENTS

First, the electrophotographic apparatus of the present invention will be described specifically based on accompanying drawings.

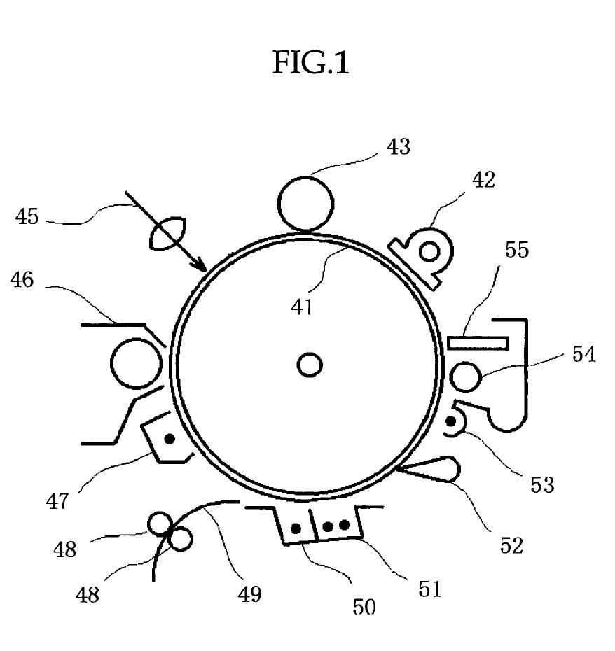

FIG. 1 is a schematic view for explaining the electrophotographic process and electrophotographic apparatus of the present invention. The present invention also embraces a modification example as described below.

Essentially, it takes 200 msec or less for the surface of the photoconductor to move between an image exposure portion (a light irradiator) (45) and a development unit (46). The time from the light irradiator to the developer, namely the time that the surface of the electrophotographic photoconductor exposed by the light irradiator required to reach the developer, is determined by dividing, by the linear velocity of the photoconductor, a portion of the circumference from the surface position of photoconductor corresponding to the center of the image exposure portion to the surface of the photoconductor corresponding to the center of the development unit.

The photoconductor (41) has, disposed on a conductive support thereof, a photosensitive layer including at least a charge generation layer and a charge transport layer and the charge generation layer contains titanyl phthalocyanine crystals having, as a diffraction peak (±0.2°) of Bragg angle 2θ with respect to CuKα ray (wavelength: 1.542 angstrom), a maximum diffraction peak at least at 27.2°, main peaks at 9.4°, 9.6° and 24.0°, and a peak at 7.3° as a diffraction peak on the lowest angle side, and not having a peak within a range of from 7.4 to 9.3°. The photoconductor (41) is in the form of a drum, but it may be in the form of a sheet or endless belt. As a charging roller (43), a pre-transfer charger (47), a transfer charger (59), a separation charger (51), and a pre-cleaning charger (53), known members such as corotron, scorotron, solid state charger, charging roller and transfer roller are usable.

Of these charging systems, a contact charging system or a non-contact proximal charging system is especially desirable for at least a charging member (shown as a charging roller (43) in FIG. 1) used for main charging of a photoconductor. A contact charging system or a non-contact proximal charging system charging member has such merits as high charging efficiency, a less production amount of ozone, and possibility of size reduction.

The term “contact charging system charging member” as used herein means a charging member whose surface is brought into contact with the surface of a photoconductor. Examples of it include a charging roller, a charging blade and charging brush. Of these, a charging roller and a charging brush are preferably used.

The term “proximal charging system charging member” as used herein means a charging member which is not brought into contact with but proximal to the surface of the photoconductor so as to have a gap of 200 μm or less between the surface of a photoconductor and the surface of the charging member. When this gap is excessively large, charging is not conducted stably and when this gap is excessively small, there is a possibility of the surface of the charging member stained by a toner, if any, remaining on the photoconductor. The gap ranging from 10 μm to 200 μm, preferably 10 μm to 100 μm is desirable. Judging from the size of the gap, such a charging member must be distinguished from known charge wire type chargers typified by corotron and scorotron and contact system charging members such as charging roller, charging brush and charging blade.

Since such a proximal charging member is disposed while having, at the surface thereof, no contact with the surface of a photoconductor, it has such merits as less toner contamination onto the surface of the charging member, less abrasion on the surface of the charging member and a less physical/chemical deterioration on the surface of the charging member. Durability of the charging member itself can therefore be heightened. When by using a contact system charging member, troubles as described above occur and durability of the charging member lowers, repeated use of it in an electrophotographic apparatus leads to lowering in charging capacity or irregular charging. In order to avoid such a charging failure, countermeasures such as increase in voltage applied to the charging member are taken, depending on a lowering degree in the charging capacity in repeated use. In this case, a hazard to the photoconductor due to charging becomes large, resulting in a deterioration in the durability of the photoconductor or formation of abnormal images. In addition, the durability of the charging member itself lowers with an increase in the voltage applied to the charging member. Use of a non-contact system charging member, on the other hand, stabilizes the charging capacity of the charging member owing to heightening of durability of the charging member, leading to an improvement in the durability and stability of the charging member, photoconductor and even the whole system.

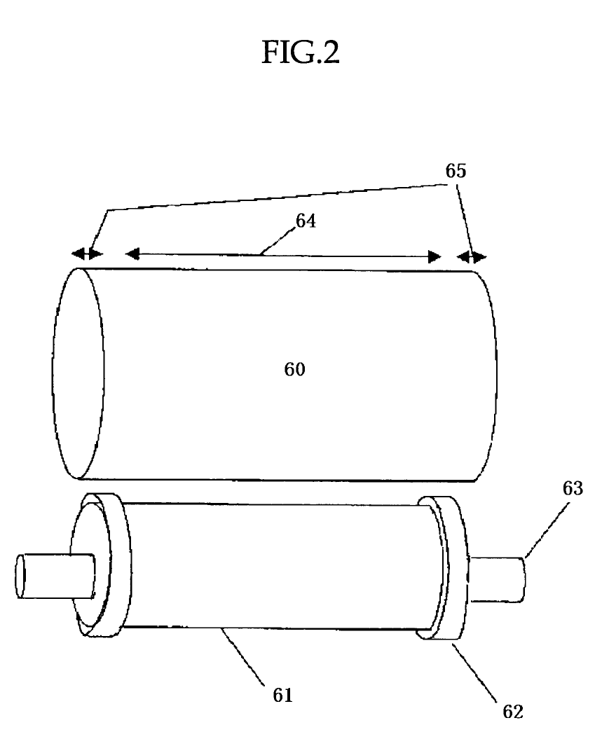

The proximal charging member to be used in the present invention may be in any form insofar as it can properly control the gap between the surface thereof and the surface of the photoconductor. For example, the charging member may be disposed so as to have a proper gap by mechanically fixing the rotation axis of the photoconductor and the rotation axis of the charging member. Especially, examples of a method capable of maintaining a gap stably in a simple manner include a method of using a charging member in the form of a charging roller, disposing a gap forming members at both ends of a non image forming area of the charging member, bringing only this area into contact with the surface of the photoconductor without bringing an image forming area into contact with the surface of the photoconductor; or a method of disposing the gap forming members at both ends of the non image forming area of the photoconductor, bringing only this area into contact with the surface of the charging member without bringing the image forming area into contact with the surface of the charging member. Particularly, methods as described in Japanese Patent Application Laid-Open (JP-A) Nos. 2002-148904 and 2002-148905 are preferred. One example of proximal charging mechanisms having a gap forming member disposed on the charging member side is illustrated in FIG. 2. Gap forming members (62) are disposed at non image forming areas (65) on both ends of a charging roller (61) having a metal shaft (63) and only these areas are brought into contact with the surface of a photoconductor (60) while disposing an image forming region (64) not in contact with the surface of the photoconductor. This system is preferred, because it has such merits as high charging efficiency, a less production amount of ozone, possibility of reduction in the size of the apparatus, no contamination with a toner and no mechanical abrasion caused by the contact.

Voltage is preferably applied to the charging member by using a superimposed alternating voltage, because it hardly causes irregular charging. Particularly in a tandem type full color image forming apparatus which will be described later, irregular charging generated in a monochrome image forming apparatus leads to uneven density of a halftone image and moreover, leads to a serious problem such as deterioration in color balance (color reproduction). By superimposing an AC component on a DC component, the above-described problems will be alleviated greatly. When the conditions of the AC component (frequency and peak-peak voltage) are excessively severe, however, a hazard on the photoconductor becomes large, happening to accelerate a deterioration of the photoconductor. It is therefore necessary to suppress the superimposition of an AC component to the minimum level.

The frequency of an AC component varies, depending on the linear velocity of the photoconductor or the like, but it is preferably 3 kHz or less, preferably 2 kHz or less. When the relationship between a voltage applied to the charging member and a potential charged to the photoconductor is plotted, a region of the photoconductor free of charging appears in spite of voltage application and from a certain point, a charging buildup potential is recognized. A peak-peak voltage about twice as much as this buildup potential is most suited (usually, about 1200 to 1500V). Sometimes, a peak-peak voltage twice as much as this buildup potential is insufficient when the charging capacity of the photoconductor is low or the linear speed is considerably high. When the photoconductor has good charging property, on the contrary, potential stability is sometimes sufficient at a peak-peak voltage less than twice as much as the buildup potential. Accordingly, the peak-peak voltage is three times as much as the buildup potential or less, preferably two times or less. In terms of an absolute value, the peak-peak voltage is 3 kV or less, preferably 2 kV or less, more preferably 1.5 kV or less.

As the image exposure portion (45), a light source capable of keeping a high luminance and permitting writing at a high resolution of 600 dpi or greater such as light emitting diode (LED), semiconductor laser (LD) or electroluminescence (EL) is employed. Image forming operation (image writing by light source) in the electrophotographic apparatus consumes light exposure (exposure energy) of 5 erg/cm² or less at the maximum. The term “light exposure at the maximum” as used herein means a light amount upon writing when an image light is written as a binary image and when it is written as another gradation (multi-valued), the lowest potential corresponds to a writing light amount to be graded (the highest image density). When a plurality of light sources are used and writing is conducted while overlapping them as needed, the light exposure at the maximum is a total maximum light amount.

Exposure energy can be determined in the following manner. When LD is used, writing is usually conducted by scanning the surface of the photoconductor by using a polygon mirror or the like. The exposure energy written on the photoconductor can be determined from the relationship among the light amount (power) of a static beam, the effective scanning term ratio (it shows how much light transformed by a polygon mirror is used effectively and it is expressed as a ratio of an effective deflection angle to a deflection angle per facet of a polygon mirror), effective writing width and linear speed of the photoconductor.

$$Exposure energy = ( static power \times effective scanning term ratio ) / ( effective writing width \times linear speed of photoconductor )$$

As a light source used for a charge eliminating lamp (42), any of the illuminants such as fluorescent lamp, tungsten lamp, halogen lamp, mercury lamp, sodium lamp, light emitting diode (LED), semiconductor laser (LD) and electroluminescence (EL) is usable. In order to irradiate only the light having a desired wavelength range, various filters can be used, for example, sharp-cut filters, bandpass filters, near-infrared cut filters, dichroic filters, interference filters and color conversion filters. Of these light sources, light emitting diode and semiconductor laser are preferred, because since they have high irradiation energy and have a long wavelength light at 600 to 800 nm, a specific crystal type phthalocyanine pigment which is a charge generation material used in the present invention exhibits high sensitivity.

Such light sources can also be used in the step other than that illustrated in FIG. 1, for example, a transferring step, charge eliminating step, cleaning step or pre-exposure step, each using light irradiation in combination, whereby light is irradiated to the photoconductor.

The above-described charge eliminating mechanism can be omitted when the above-described charging system is employed while superimposing an AC component, or when a residual potential of the photoconductor is small. Not an optical charge eliminator but a static charge eliminating mechanism (for example, a charge eliminating brush to which a reverse bias has been applied or has been grounded) can be used alternatively.

The toner developed on the photoconductor (41) by a developing unit (46) is transferred onto a transfer paper (49). The developed toner is not transferred completely and some toner remains on the photoconductor (41). Such residual toner is removed from the photoconductor by a fur brush (54) and a blade (55). The cleaning may be conducted only with a cleaning brush. Known cleaning brushes including fur brush and mug fur brush are usable. When a transfer efficiency is high and a residual toner amount is small, such a cleaning mechanism can of course be omitted.

When the electrophotographic photoconductor is positively (negatively) charged and then subjected to image exposure, a positive (negative) electrostatic latent image is formed on the surface of the photoconductor.

This latent image is developed by using a toner (charge detecting particles) having negative (positive) polarity to form a positive image, while it is developed by using a toner having positive (negative) polarity to form a negative image.

To such developers, known methods are applied. Also to charge eliminators, known methods are applied. Indicated at numeral (48) is a resist roller and (52) a separating claw.

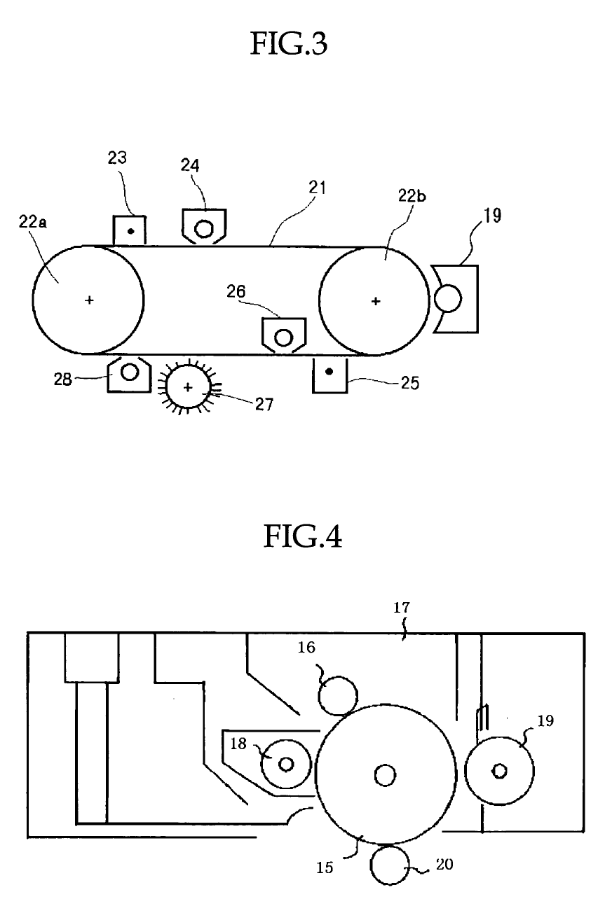

FIG. 3 illustrates another example of the electrophotographic process of the present invention. Also in this case, the time necessary for the surface of the photoconductor to move between the image exposure portion (24) and developing unit (30) must be 200 msec or less. The photoconductor (21) has, disposed on the conductive support thereof, a photosensitive layer including a charge generation layer and a charge transport layer. The charge generation layer contains titanyl phthalocyanine crystals having, as a diffraction peak (±0.2°) of Bragg angle 2θ with respect to CuKα (wavelength: 1.542 angstrom), a maximum diffraction peak at least at 27.2°, main peaks at 9.4°, 9.6° and 24.0°, and a peak at 7.3° as a diffraction peak on the lowest angle side, and not having a peak within a range of from 7.4 to 9.3°. The photoconductor (21) is driven by driving rollers (22a) and (22b), and charging with a charger (23), exposure to a light source (24) to form an image, development (not illustrated), transfer by a charger (25), pre-cleaning exposure by a light source (26), cleaning with a brush (27), and charge elimination by a light source (28) are repeated. In FIG. 3, the photoconductor (21) (having, of course, a translucent support) is irradiated from the support side for image exposure. As an image exposure light source (24) having a resolution of 600 dpi or greater, LD or LED is preferred and it is used at a maximum light exposure (exposure energy) of 5 erg/cm² or less.

The electrophotographic process as illustrated above is only an example of the embodiment of the present invention and another embodiment is also possible. For example, in FIG. 3, pre-cleaning exposure is conducted from the side of the photoconductor, but it may be conducted from the side of the translucent support side, or the exposure for charge elimination may be conducted from the support side.

On the other hand, as the light irradiation step, image exposure, pre-cleaning exposure and charge eliminating exposure are illustrated. The photoconductor is also exposed to light by disposing another known light irradiation step, for example, pre-transfer exposure or exposure prior to image exposure.

The image forming apparatus as described above can be incorporated in a copy machine, facsimile machine or printer while being fixed thereto, or it may be incorporated in such an apparatus as a process cartridge. The term “process cartridge” as used herein means a single device (part) having a built-in photoconductor and the other members including a charger, a light irradiator, a developer, a transfer, a cleaner and a charge eliminator. The process cartridge has a variety of shapes and one conventional example is shown in FIG. 4. Also in this case, it is essential that the time necessary for the surface of the photoconductor to move from an image exposure portion (17) to a developing unit (19) must be 200 msec or less. The photoconductor (15) has, disposed on the conductive support thereof, a photosensitive layer including at least a charge generation layer and a charge transport layer and the charge generation layer contains titanyl phthalocyanine crystals having, as a diffraction peak (±0.2°) of Bragg angle 2θ with respect to CuKα ray (wavelength: 1.542 angstrom), a maximum diffraction peak at least at 27.2°, main peaks at 9.4°, 9.6° and 24.0°, and a peak at 7.3° as a diffraction peak on the lowest angle side, and not having a peak within a range of from 7.4 to 9.3°. When this process cartridge is used as an image formation apparatus, image writing light having a resolution of 600 dpi or greater is irradiated at the maximum light exposure (exposure energy) of 5 erg/cm² or less. Around the photoconductor (15), disposed are a charging roller (16), a transfer roller (20) and a cleaning brush (18).

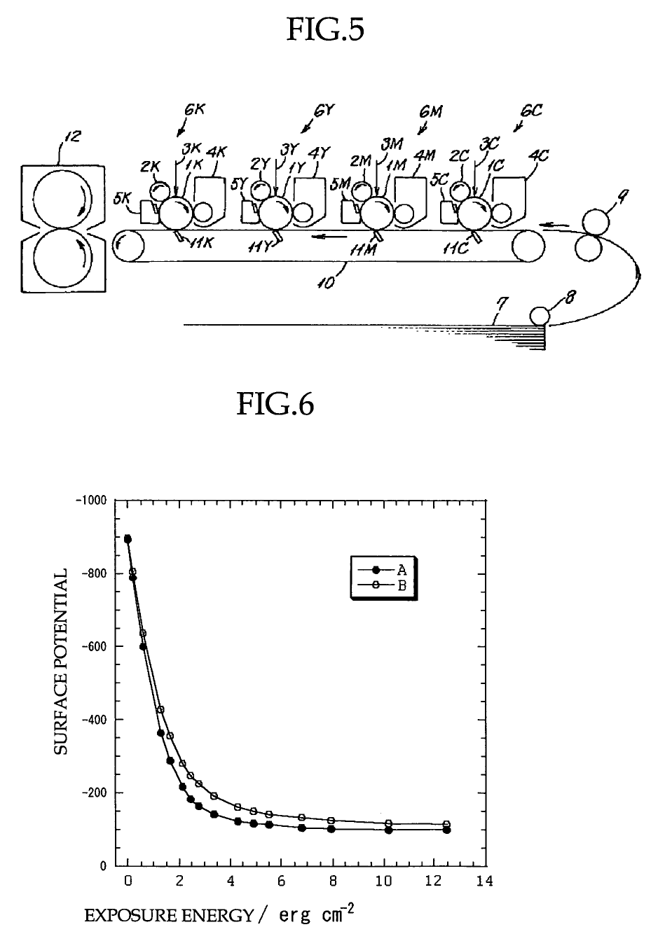

FIG. 5 is a schematic view for explaining a tandem full-color electrophotographic apparatus of the present invention and modification examples as described below belong to the scope of the present invention.

As illustrated in FIG. 5, drum-like photoconductors (1C, 1M, 1Y and 1K) each has, on the conductive support thereof, a photosensitive layer including at least a charge generation layer and a charge transport layer. The charge generation layer contains titanyl phthalocyanine crystals having, as a diffraction peak (±0.2°) of Bragg angle 2θ with respect to CuKα (wavelength: 1.542 angstrom), a maximum diffraction peak at least at 27.2°, main peaks at 9.4°, 9.6° and 24.0°, and a peak at 7.3° as a diffraction peak on the lowest angle side, and not having a peak within a range of from 7.4 to 9.3°. These photoconductors (1C, 1M, 1Y and 1K) turn in the direction indicated by the arrow in the diagram and around them, at least charging members (2C, 2M, 2Y and 2K), developing members (4C, 4M, 4Y and 4K) and cleaning members (5C, 5M, 5Y and 5K) are disposed. The charging members (2C, 2M, 2Y and 2K) constitute a charger capable of uniformly charging the surface of the photoconductor. Laser beams (3C, 3M, 3Y and 3K) having a resolution of 600 dpi or greater are irradiated by an unillustrated charging member from the reverse side of the photoconductor between these charging members (2C, 2M, 2Y and 2K) and developing members (4C, 4M, 4Y and 4K) to form an electrostatic latent image on the photoconductors (1C, 1M, 1Y and 1K), respectively. In this case, the laser light is irradiated at the maximum light exposure (exposure energy) of 5 erg/cm² or less. Here, it is essential that the time necessary for the surface of the photoconductor to move between the image exposure portions (3C, 3M, 3Y, 3K) and developing units (4C, 4M, 4Y and 4K) must be 200 msec or less. Four image forming elements (6C, 6M, 6Y and 6K) based on such photoconductors (1C, 1M, 1Y and 1K) are arranged in series along a transfer carrying belt (10) serving as a transfer material conveyer. The transfer carrying belt (10) is in contact with the photoconductors (1C, 1M, 1Y, 1K) between the developing members (4C, 4M, 4Y, 4K) and the cleaning members (5C, 5M, 5Y, 5K) of the image forming units (6C, 6M, 6Y, 6K). Transferring brushes (11C, 11M, 11Y and 11K) for applying transfer biases are disposed on the surface (back surface) of the transfer carrying belt (10) opposite to the photoconductors. The image forming elements (6C, 6M, 6Y, 6K) have a similar constitution except that they differ in the color of the toner inside of the developer.

In the color electrophotographic apparatus having the structure as illustrated in FIG. 5, image formation proceeds as described below. First, the photoconductors (1C, 1M, 1Y, 1K) in the image forming elements (6C, 6M, 6Y, 6K) are charged by the charging members (2C, 2M, 2Y, 2K) which turn in the direction of the arrows (turns interactively with the photoconductor). At exposure portions (not illustrated) disposed inside of the photoconductors, electrostatic latent images corresponding to the image of each color are formed by the laser lights (3C, 3M, 3Y, 3K). The electrostatic latent images are then developed by the developing members (4C, 4M, 4Y, 4K) to form toner images. The developing members (4C, 4M, 4Y, 4K) carry out development by using cyan (C), magenta (M), yellow (Y) and black (K) toners and the toner images of colors formed on the four photoconductors (1C, 1M, 1Y, 1K) are then overlaid each other on a transfer paper.

The transfer paper (7) is fed from a tray by using a paper feed roller (8). It once stops by a pair of resist rollers (9) and then conveyed to the transfer carrying belt (10) in timing with the image formation on the photoconductors. The transfer paper (7) held on the transfer carrying belt (10) is then transported and at a contact position (transfer portion) with the photoconductors (1C, 1M, 1Y, 1K), the toner image of each color is transferred. The toner image on each photoconductor is transferred onto the transfer paper (7) by an electric field derived from a difference in the potential between the transfer bias applied to the transferring brushes (11C, 11M, 11Y, 11K) and the photoconductors (1C, 1M, 1Y or 1K). The paper (7) having passed through the four transfer regions and having the toner images of the four colors overlaid thereon is conveyed to a fixing device (12) at which the toner is fixed and then the paper is ejected from a rejecting member which is not illustrated. The toner remaining on the photoconductors (1C, 1M, 1Y, 1K) without being transferred at the transfer regions is collected by cleaners (5C, 5M, 5Y, 5K), respectively. In the example illustrated in FIG. 5, the colors of the image forming elements are, from the upstream side toward the downstream side of the transfer paper conveying direction, cyan (C), magenta (M), yellow (Y) and black (K). The order of the colors is not limited thereto but can be set as desired. When a manuscript is made only in black color, it is particularly effective in the present invention to install a mechanism capable of terminating the image forming elements (6C, 6M, 6Y) other than black color. In FIG. 5, the charging member is in contact with the photoconductor. By adopting a charging mechanism as illustrated in FIG. 2, thereby disposing a suitable gap (about 10 to 200 μm) between the charging member and photoconductor, the abrasion amount therebetween can be reduced and toner filming on the charger member can be reduced. Thus, such a charging mechanism is preferably employed.

The image forming apparatus as described above can be incorporated in a copy apparatus, a facsimile or a printer while being fixed thereto, and each electrophotographic element may be incorporated in such an apparatus as a process cartridge. The process cartridge is a single device (part) having a built-in photoconductor and other members including a charger, a light irradiator, a developer, a transfer, a cleaner and a charge eliminator.

The advantages of the present invention will next be considered.

The electrophotographic apparatus of the present invention aims at high speed and high resolution region. Accordingly, the system is operated in a region of 150 mm/sec or greater (more preferably, 200 mm/sec or greater) in terms of the linear velocity of the photoconductor and the beam system of write light by LD or LED is conducted at 50 μm or less (preferably 30 μm or less) corresponding to the resolution of 600 dpi or greater (preferably, 1200 dpi or greater). In such a case even if the output of a light source is increased, exposure energy reaching the surface of the photoconductor cannot be increased proportionally. Unless the lifetime of a light source and output stability are neglected, the exposure energy on the surface of the photoconductor is 10 erg/cm² or less at most.

Such an optical system usually cannot be exchanged easily and it is designed to have a lifetime similar to that of the electrophotographic apparatus itself. In consideration of the fabrication accuracy (lot difference) of the device, stability under the using environment, ensuring of lifetime and output stability upon continuous operation, it is preferred to use the device with a power about half of that upon full output.

As the properties (light attenuation properties) of a photoconductor in such a system, both high response (more prompt potential attenuation) and high gain (greater potential attenuation) are requested. Concerning high response, owing to the recent development of a charge transport material, the photoconductor has come to be usable, as described above, for a high speed system in which the time between writing to development is 100 msec or less. Generation of light carriers of the photoconductor in a region of reciprocity failure owing to writing of a high intensity such as laser light also contributes to this fact.

Concerning high gain, as a result of development of a charge generation material along with the development of a charge transport material, a charge generation material exhibiting a considerably high quantum efficiency has been developed successfully. The specific crystal type titanyl phthalocyanine crystals are one example of it. Even if a gain amount can be raised, however, the optimum utilization (writing of a minute area, a reduction of a write light amount upon high speed writing) of a light source is not completely satisfied, judging from sharpness of light attenuation. Such a situation is illustrated in FIG. 6.

In FIG. 6, B(o) shows light attenuation properties of a photoconductor using, as a charge generation material, titanyl phthalocyanine crystals so far developed (crystals having a maximum diffraction peak at least at 27.2° as a diffraction peak of Bragg angle 2θ with respect to CuKα ray). In FIG. 6, A(•) shows light attenuation properties of a photoconductor using a charge generation material (specific crystal type titanyl phthalocyanine) to be used in the present invention. These charge generation substances are set equal in the their adhesion amount so that their difference (in a low electric field) corresponds to that in quantum efficiency.

In the case of light attenuation properties of B, light attenuation has not yet been completed at an exposure amount near 5 erg/cm², and moreover, potential (corresponding to the potential at the exposure portion) available by comparison with the optical attenuation of A is high. Although depending on the setting of the development bias, a phenomenon such as lowering in an image density or incomplete development of 1 dot tends to occur. To prevent such a phenomenon, a potential is decreased, which requires an exposure amount of 5 erg/cm² or greater. As a result, a light source is used at high luminance, which not only decreases the lifetime of the light source, but also produces side effects such as acceleration of light fatigue of the photoconductor or diffusion (causes line thickening) of a dot. In an electrophotographic apparatus carrying out writing having a resolution of 600 dpi or greater, this problem appears obviously and it must be overcome to improve resolution.

In the case of light attenuation properties of A, on the other hand, light attenuation has almost been completed at an exposure amount of about 5 erg/cm². This makes it possible to set the output of a light source low, and bring about an improvement in the lifetime of a light source and stability, and reduce the light fatigue of the photoconductor. In addition, use of a high-gain photoconductor having sharpness in light attenuation lowers the potential at an unexposed portion further. It also facilitates alleviation of greasing which is a fatal defect in nega posi development. Existence of a saturated value of potential attenuation within an effective using range (a range naturally permitting light emission) facilitates light amount distribution within one dot of a writing light, which is of great advantage for the formation of a precise latent image.

When a light amount of 5 erg/cm² or greater is given to a photoconductor exhibiting light attenuation of A, a line thickening phenomenon occurs as described above. This phenomenon is however avoided by using a light amount (when indicated by A in FIG. 6, a light amount of 4.5 erg/cm² or less) smaller than that reduces the lower saturated value of the potential.

The electrophotographic photoconductor to be used in the present invention will next be described more specifically.

The electrophotographic photoconductor of the present invention is obtained by forming at least a charge generation layer and a charge transport layer on a conductive support and it contains titanyl phthalocyanine crystals having, as a diffraction peak (±0.2°) of Bragg angle 2θ with respect to CuKα ray (wavelength: 1.542 angstrom), a maximum diffraction peak at least at 27.2°, main peaks at 9.4°, 9.6° and 24.0°, and a peak at 7.3° as a diffraction peak on the lowest angle side, and not having a peak within a range of from 7.4 to 9.3°.

This crystal type is described in Japanese Patent Application Laid-Open (JP-A) No. 2001-19871. Use of these titanyl phthalocyanine crystals enables to obtain a stable electrophotographic photoconductor free from lowering in the charge property even after repeated use without losing high sensitivity. In Japanese Patent Application Laid-Open (JP-A) No. 2001-19871, disclosed are a charge generation substance used in the present application and a photoconductor and electrophotographic apparatus using the substance. When writing was conducted at a resolution of 600 dpi or greater, however, a letter thickening phenomenon as described above occurred unless the amount of a write light was adjusted properly, leading to a substantial deterioration in resolution. Such a phenomenon is more marked in the photoconductor using the material as described in the above gazette than in the photoconductor having a lower sensitivity. Thus, the actual ability of the material as described in the gazette is not sufficiently exhibited in the conventional process (apparatus) and moreover, the material produces side effects unless the processing conditions are properly adjusted.

As a synthesizing process of titanyl phthalocyanine crystals, a process not using a titanium halide as a raw material is preferred as described in Japanese Patent Application Laid-Open (JP-A) No. 06-293769. One of the greatest merits of this process resides in that the titanyl phthalocyanine crystals thus synthesized are free of halogens. Halogenated titanyl phthalocyanine crystals contained as an impurity in titanyl phthalocyanine crystals tend to adversely affect the electrostatic properties of a photoconductor using them, thereby lowering photosensitivity or lowering electrostatic property (Japan Hardcopy '89 Collected papers, p. 103(1989)). In the present invention, halogen-free titanyl phthalocyanine crystals as described in Japanese Patent Application Laid-Open (JP-A) No. 2001-19871 are main crystals and these materials are effectively used.

Here, a synthesizing process of titanyl phthalocyanine crystals usable in the present invention and having a specific crystal type will be described.

First, a synthesizing process of a crude product of titanyl phthalocyanine crystals will be described.

Synthesizing processes of phthalocyanines are known for years and they are described, for example, in Moser, et al., “Phthalocyanine Compounds” (1963), “The Phthalocyanines” (1983), Japanese Patent Application Laid-Open (JP-A) No. 06-293769, and the like.

For example, the first process is to heat a mixture of phthalic anhydride, a metal or metal halide, and urea in the presence or absence of a high boiling point solvent. A catalyst such as ammonium molybdate is used in combination as needed. The second process is to heat a phthalonitrile and a metal halide in the presence or absence of a high boiling point solvent. This process is employed for the preparation of a phthalocyanine to which the first process cannot be applied. Examples of such a phthalocyanine include aluminum phthalocyanines, indium phthalocyanines, oxovanadium phthalocyanines, oxotitanium phthalocyanines and zirconium phthalocyanines. The third process is to react phthalic anhydride or phthalonitrile with ammonia to prepare an intermediate, for example, 1,3-diiminoisoindoline and then react the resulting intermediate with a metal halide in a high boiling point solvent. The fourth process is to react a phthalonitrile and a metal alkoxide in the presence of urea. The last process is especially useful synthesizing process of an electrophotographic material, because it does not cause chlorination (halogenation) of a benzene ring.

In the next place, a synthesizing process of amorphous titanyl phthalocyanine (low crystallinity titanyl phthalocyanine) will be described. This process is to dissolve a phthalocyanine in sulfuric acid, and diluting the resulting solution with water to cause re-precipitation. For this synthesis, the acid paste process or acid slurry process can be employed.

Described specifically, the above-described crude synthetic product is dissolved in 10 times to 50 times the amount of concentrated sulfuric acid. The insoluble matters are removed by filtration as needed. The filtrate is gradually charged in water which has been cooled sufficiently, or ice water to cause reprecipitation of titanyl phthalocyanine. The titanyl phthalocyanine thus precipitated is collected by filtration, washed with deionized water and then filtered. This operation is repeated sufficiently until the filtrate becomes neutral. After washing with clean deionized water in the end, filtration is conducted, whereby an aqueous paste having a solid concentration of from about 5% by weight to 15% by weight is obtained. The amorphous titanyl phthalocyanine (low crystallinity titanyl phthalocyanine) thus prepared is provided for use in the present invention. The amorphous titanyl phthalocyanine (low crystallinity titanyl phthalocyanine) preferably has a maximum diffraction peak at least at from 7.0° to 7.5° as a diffraction peak (10.2°) of Bragg angle 2θ with respect to a characteristic X-ray (wavelength: 1.542) of CuKα. In particular, the half-value width of the diffraction peak is preferably 1° or greater. Furthermore, the average particle diameter of primary particles is preferably 0.1 μm or less.

A description will next be made of the crystal conversion process.

Crystal conversion is conducted from the above-described amorphous titanyl phthalocyanine (low crystallinity titanyl phthalocyanine) to titanyl phthalocyanine crystals having, as a diffraction peak (±0.2°) of Bragg angle 2θ with respect to characteristic X-ray (wavelength: 1.542 angstrom) of CuKα, a maximum diffraction peak at least at 27.2°, main peaks at 9.4°, 9.6° and 24.0°, and a peak at 7.3° as a diffraction peak on the lowest angle side, and having neither a peak within a range of from 7.4° to 9.4° nor a peak at 26.3°.

More specifically, the above-described crystal type is obtained by, without drying the above-described amorphous titanyl phthalocyanine (low crystallinity titanyl phthalocyanine), mixing and stirring it with an organic solvent in the presence of water.

Any organic solvent is usable insofar as it permits preparation of a desired crystal type. Particularly, use of one organic solvent selected from tetrahydrofuran, toluene, methylene chloride, carbon disulfide, orthodichlorobenzene and 1,1,2-trichloroethane brings about good results. These organic solvents are preferably employed singly, but two or more of these organic solvents may be used as a mixture or they may be used with another solvent in combination.

The above-described crystal conversion method is in accordance with the method as described in Japanese Patent Application Laid-Open (JP-A) No. 2001-19871. In the charge generation substance contained in the photoconductor to be used for the electrophotographic apparatus of the present application, a reduction in the particle diameter of the titanyl phthalocyanine crystals brings about more marked effects.

As a result of the observation by the present inventors with a view toward decreasing the particle diameter of titanyl phthalocyanine crystals, it has been understood that since the above-described amorphous titanyl phthalocyanine (low crystallinity titanyl phthalocyanine) has a primary particle diameter of 0.1 μm or less (most of the particles having a particle diameter of from about 0.01 μm to 0.05 μm), the crystal conversion occurs together with the crystal growth. Usually, in such crystal conversion, sufficient crystal conversion time is secured so as to avoid remaining of the raw materials and after enough crystal conversion, filtration is conducted to obtain titanyl phthalocyanine crystals having a desired crystal type. In spite of using raw materials having a sufficiently small primary particle diameter, the crystals have a larger particle diameter (about 0.3 μm to 0.5 μm) after crystal conversion.

For dispersing the resulting titanyl phthalocyanine crystals, a strong share is applied to them to decrease the particle diameter (less than 0.3 μm, preferably 0.25 μm or less, more preferably 0.2 μm or less). If necessary, they are dispersed while giving thereto an energy strong enough to pulverize them. As a result, as described above, some particles tend to transfer to a crystal type other than the desired crystal type.

The term “particle diameter” as used herein means a volume average particle diameter and is determined using an ultra-centrifugal automatic particle size distribution analyzer “CAPA-700” (trade name; manufactured by HORIBA Ltd.). The particle diameter (median) calculated corresponds to 50% of the cumulative distribution. By this method, however, it is impossible to detect coarse particles contained in a trace amount. For obtaining more detailed data, it is therefore important to observe titanyl phthalocyanine crystal powder or dispersion directly by an electron microscope, thereby determining its diameter.

With the foregoing in view, it is effective to reduce the diameter of primary particles prepared upon crystal conversion as much as possible. For this purpose, what is effective is selection of a proper solvent for crystal conversion as described above, and vigorous stirring for bringing the solvent into sufficient contact with an aqueous paste of titanyl phthalocyanine (raw material prepared as described above) in order to complete crystal conversion in a short time while heightening the crystal conversion efficiency. More specifically, stirring using a propeller having an extremely strong stirring power or a powerful stirrer (dispersing tool) such as homogenizer (homomixer) can actualize crystal conversion in a short time. Under such conditions, the crystal conversion is conducted sufficiently without leaving raw materials and titanyl phthalocyanine crystals free of crystal growth are available.

The crystal particle diameter has a proportional relation with crystal conversion time as described above so that it is also effective to terminate the reaction as soon as completion of a predetermined reaction (crystal conversion). The reaction is terminated by the addition of a large amount of a solvent in which crystal conversion does not occur smoothly as soon as the crystal conversion is completed. Examples of such a solvent include alcohol and ester solvents. The crystal conversion can be terminated by adding 10 times the amount of such a solvent relative to the solvent used for crystal conversion. By adopting such a crystal conversion method, the primary particle size of titanyl phthalocyanine crystals can be reduced (less than 0.3 μm, preferably 0.25 μm or less, more preferably 0.2 μm or less). Use of the technique as described in Japanese Patent Application Laid-Open (JP-A) No. 2001-19871 and, if necessary the above-described technique (crystal conversion method to obtain fine titanyl phthalocyanine crystals) in combination is effective for heightening the advantage of the invention.

The titanyl phthalocyanine crystals are filtered just after crystal conversion and separated from the solvent for crystal conversion. This filtration is effected through a filter of a proper size. Filtration under reduced pressure is most preferred for this purpose.

The titanyl phthalocyanine crystals thus separated by filtration are dried under heat as needed. Although any known dryer is usable for the drying under heat, a blow type one is preferred when drying is conducted in the atmosphere. Drying under reduced pressure is also effective in order to raise the drying speed and bring about advantages of the present invention more clearly. It is particularly effective for the materials which undergo decomposition or change in crystal type at high temperatures. Drying under a vacuum condition higher than 10 mmHg is particularly effective.

The resulting titanyl phthalocyanine crystals having a predetermined crystal type are very useful as a charge generation substance for an electrophotographic photoconductor. As described above, however, they conventionally involved such a drawback that their crystal type was not stable and conversion of crystal type tended to occur upon preparation of a dispersion of the crystals. By synthesizing primary particles having a particle diameter as small as possible as described above, it becomes possible to prepare a dispersion having a small average particle diameter without applying an excessive shear stress on the crystals upon preparation of the dispersion and stabilize the crystal type (without changing the synthesized crystal type).

An ordinarily employed method is adopted for the preparation of the dispersion. It is available by dispersing the titanyl phthalocyanine crystals and if necessary a binder resin in a proper solvent by using a ball mill, attritor, sand mill, beads mill or ultrasonic wave. The binder resin may be selected in consideration of electrostatic properties of the photoconductor, while the solvent may be selected in consideration of wetness of the pigment with the solvent and dispersibility of the pigment.

As described above, it is known that titanyl phthalocyanine crystals having a maximum diffraction peak at least at 27.2° as a diffraction peak (±0.2°) of Bragg angle 2θ with respect to CuKα (wavelength: 1.542 angstrom) easily transfer to another crystal type by the stress such as thermal energy or mechanical shear. This tendency also applies to the titanyl phthalocyanine crystals used in the present invention. Described specifically, it is necessary to adopt an appropriate dispersing method in order to prepare a dispersion containing fine particles, but stabilization of the crystal type and particle diameter reduction tend to be in a trade-off relation. Optimization of the dispersing conditions is one method to avoid it, but it narrows the preparation conditions. A more convenient method is therefore desired. A method as described below is also effective in order to overcome this problem.

Described specifically, after a dispersion of particles having a particle diameter made as fine as possible within an extent not causing crystal transfer, the dispersion is filtered through a proper filter. By this method, coarse particles which remain in a trace amount but cannot be observed visually (or cannot be detected by particle diameter measurement) can be removed. This method is also effective to obtain a uniform particle size distribution. More specifically, the resulting dispersion is filtered through a filter having an effective pore size of 3 μm or less to complete preparation of the dispersion. By this method, a dispersion containing only titanyl phthalocyanine crystals having a small particle diameter (less than 0.3 μm, preferably 0.25 μm, more preferably 0.2 μm or less) can be prepared. By installing the photoconductor for which such a dispersion has been used, the advantages of the present application become more marked.

The electrophotographic photoconductor to be used in the present invention will next be described more specifically based on accompanying drawings.

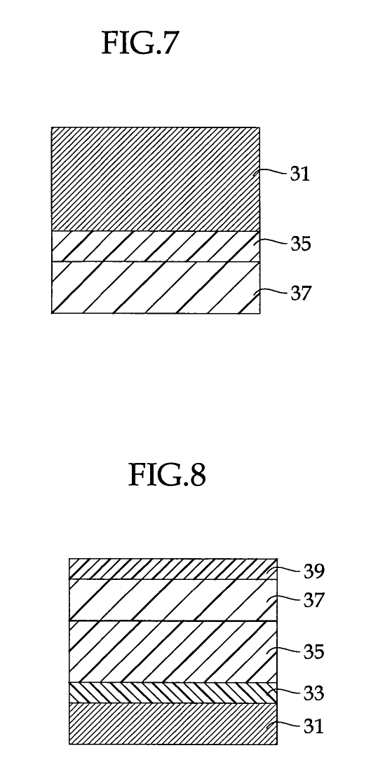

FIG. 7 is a cross-sectional view illustrating one constitution example of the electrophotographic photoconductor to be used in the present invention, in which a charge generation layer (35) composed mainly of a charge generation material and a charge transport layer (37) composed mainly of a charge transport material have been stacked over a conductive support (31).

FIG. 8 is a cross-sectional view illustrating another constitution example of the electrophotographic photoconductor to be used in the present invention, in which an intermediate layer (33), a charge generation layer (35) composed mainly of a charge generation material and a charge transport layer (37) composed mainly of a charge transport material have been stacked over a conductive support (31).

As the conductive support (31), usable here are those obtained by applying a substance having a volume resistance of 10¹⁰ Ω·cm or less, thus exhibiting conductivity, for example, a metal such as aluminum, nickel, chromium, nichrome, copper, gold, silver or platinum or a metal oxide such as tin oxide or indium oxide to a plastic in the film or cylinder form or paper by evaporation or sputtering; or tubes obtained by extruding or drawing a plate or the like made of aluminum, aluminum alloy, nickel or stainless steel to fabricate an element tube, and then subjecting the element tube to surface treatment such as cutting, super finishing or polishing. Alternatively, an endless nickel belt or endless stainless belt as disclosed in Japanese Patent Application Laid-Open (JP-A) No. 52-36016 can be used as the conductive support 1.

Of these, a cylindrical support made of aluminum which can be subjected to anodizing coating treatment easily is most preferably employed. The term “aluminum” as used herein embraces both pure aluminum and aluminum alloys. More specifically, aluminum of JIS-1000s, JIS-3000s and JIS-6000s and alloys thereof are most suited. An anodized film is obtained by anodizing various metals or alloys in an electrolyte solution. So-called alumite obtained by anodizing aluminum or aluminum alloy in an electrolyte solution is most suited for the photoconductor to be used in the present invention. In particular, alumite is superior, because it can prevent generation of point defects (black spots, swear of background) which will otherwise occur when used for reversal development (nega posi development).

The anodization is conducted in an acidic bath of chromic acid, sulfuric acid, oxalic acid, phosphoric acid, boric acid, or sulfamic acid. Of these, treatment in a sulfuric acid bath is most suited. For example, it is conducted under the following conditions: a sulfuric acid concentration of 10 to 20%, a bath temperature of 5° C. to 25° C., a current density of 1 to 4 A/dm², an electrolytic voltage of 5V to 30V, and treatment time of about 5 minutes to 60 minutes, but the conditions are not limited thereto. The anodic oxide coating formed as described above is porous and highly insulative so that its surface is quite unstable. Since the coating thus formed undergoes a change with the passage of time, fluctuations in physical properties tend to occur. In order to avoid this, it is preferred to carry out sealing treatment. Examples of the sealing treatment include a method of immersing the anodic oxide coating in an aqueous solution containing nickel fluoride or nickel acetate, a method of immersing the anodic oxide coating in boiling water, and a method of treating the anodic oxide coating with pressurized water vapor. Of these, the method of immersing the anodic oxide coating in an aqueous solution containing nickel acetate is most preferred.

The sealing treatment is followed by washing treatment of the anodic oxide film. A main object of this washing treatment is to remove excessively existing substances such as metallic salts attached upon the sealing treatment. When such substances exist excessively on the surface of the support (anodic oxide coating), they not only adversely affect the quality of a film formed thereon, but also remaining of a low-resistance component becomes a cause for swear of the background. Washing may be conducted once with pure water, but usually plural times. It is preferred that the last washings are as pure (deionized) as possible. One of the plural washing steps is preferably a step of washing while physically rubbing with a contact member. The thickness of the anodic oxide coating thus formed is preferably 5 μm to 15 μm. The anodic oxide coating thinner than the above-described range cannot serve as a barrier of the anodic oxide coating fully. If the anodic oxide coating is thicker than the above-described range, on the other hand, the time constant of it as the electrode becomes too large, which happens to generate a residual potential or lower the response of the photoconductor.

The above-described support to which a dispersion of conductive powder in a suitable binder resin has been applied can also be used as the conductive support (31) of the present invention. Examples of the conductive powder include carbon black, acetylene black, metal powder such as aluminum, nickel, iron, nichrome, copper, zinc and silver, and metal oxide powder such as conductive tin oxide and ITO. Examples of the binder resin used with the powder include thermoplastic, thermosetting and photosetting resins such as polystyrene, styrene-acrylonitrile copolymer, styrene-butadiene copolymer, styrene-maleic anhydride copolymer, polyester, polyvinyl chloride, vinyl chloride-vinyl acetate copolymer, polyvinyl acetate, polyvinylidene chloride, polyarylate resin, phenoxy resin, polycarbonate, cellulose acetate resin, ethyl cellulose resin, polyvinyl butyral, polyvinylformal, polyvinyltoluene, poly-N-vinyl carbazole, acrylic resin, silicone resin, epoxy resin, melamine resin, urethane resin, phenol resin and alkyd resin. Such a conductive layer can be formed, for example, by applying a dispersion obtained by dispersing the conductive powder and binder resin in a proper solvent such as tetrahydrofuran, dichloromethane, methyl ethyl ketone or toluene.

Moreover, those having a conductive layer disposed on a proper cylindrical substrate such as a heat shrinkable tubing obtained by incorporating the above-described conductive powder in a material such as polyvinyl chloride, polypropylene, polyester, polystyrene, polyvinylidene chloride, polyethylene, chlorinated rubber, or polytetrafluoroethylene fluorine resin are usable favorably as the conductive substrate (31) of the present invention.

Next, a description will be made of the photosensitive layer. As the photosensitive layer, a laminate type having a charge generation layer (35) and a charge transport layer (37) is preferred, because it exhibits excellent properties such as sensitivity and durability.

The charge generation layer (35) contains a charge generation substance converted to a crystal type having, as a diffraction peak (±0.2°) of Bragg angle 2θ with respect to characteristic X-ray (wavelength: 1.542 angstrom) of CuKα, a maximum diffraction peak at at least 27.2°. Of the above-described type crystals, titanyl phthalocyanine crystals having, in addition, a main peak at 9.4°, 9.6° and 24.0°, having a peak at 7.30 as a diffraction peak on the lowest angle side, and not having a peak within a range of from 7.4 to 9.30 are preferred, with those free of a peak at 26.3° furthermore being particularly preferred. A reduction in the average particle diameter of the primary particles of these crystals to less than 0.3 μm (preferably, 0.25 μm or less, more preferably 0.2 μm or less) is effective for bringing about a marked effect in the present invention.

The charge generation layer (35) can be formed by dispersing both the above-described pigment and, if necessary, a binder resin in a proper solvent by using a ball miller, attritor, sand mill or supersonic wave, applying the resulting dispersion onto a conductive support and then drying.

Examples of the binder resin to be used for the charge generation layer (35) if necessary include polyamide, polyurethane, epoxy resins, polyketone, polycarbonate, silicone resins, acrylic resins, poly(vinyl butyral), polyvinyl formal, polyvinyl ketone, polystyrene, polysulfone, poly-N-vinylcarbazole, polyacrylamide, polyvinylbenzal, polyester, phenoxy resin, vinyl chloride-vinyl acetate copolymer, polyvinyl acetate, polyphenylene oxide, polyamide, polyvinylpyridine, cellulose resins, casein, polyvinyl alcohol, and polyvinylpyrrolidone. The binder resin is added in an amount of from 0 to 500 parts by weight, preferably from 10 to 300 parts by weight, based on 100 parts by weight of the charge generation substance.

Examples of the solvent usable in the above reaction include isopropanol, acetone, methyl ethyl ketone, cyclohexanone, tetrahydrofuran, dioxane, ethyl cellosolve, ethyl acetate, methyl acetate, dichloromethane, dichloroethane, monochlorobenzene, cyclohexane, toluene, xylene, and ligroin. The coating solution can be applied by using dipping coating, spray coating, bead coating, nozzle coating, spinner coating and ring coating. The thickness of the charge generation layer (35) is preferably from about 0.01 μm to 5 μm, more preferably from 0.1 μm to 2 μm.

The charge transport layer 5 can be formed by dissolving or dispersing a charge transport substance and a binder resin in a suitable solvent, applying the resulting solution or dispersion onto the charge generation layer, and then drying. If necessary, a plasticizer, a leveling agent, an antioxidant or the like can be added further to the solution or dispersion.

The charge transport substances can be classified into hole conducting substances and electron conducting substances. Examples of the charge transport substances include electron-acceptable substances such as chloranil, bromanil, tetracyanoethylene, tetracyanoquinodimethane, 2,4,7-trinitro-9-fluorenone, 2,4,5,7-tetranitro-9-fluorenone, 2,4,5,7-tetranitroxanthone, 2,4,8-trinitrothioxanthone, 2,6,8-trinitro-4H-indeno [1,2-b]thiophen-4-one, 1,3,7-trinitrodibenzothiophene-5,5-dioxide and benzoquinone derivatives.

Examples of the hole conducting materials include known materials such as poly-N-vinylcarbazole and derivatives thereof, poly-γ-carbazolylethylglutamate and derivatives thereof, pyrene-formaldehyde condensate and derivatives thereof, polyvinylpyrene, polyvinylphenanthrene, polysilane, oxazole derivatives, oxadiazole derivatives, imidazole derivatives, monoarylamine derivatives, diarylamine derivatives, triarylamine derivatives, stilbene derivatives, α-phenylstilbene derivatives, benzidine derivatives, diarylmethane derivatives, triarylmethane derivatives, 9-styrylanthracene derivatives, pyrazoline derivatives, divinylbezene derivatives, hydrazone derivatives, indene derivatives, butadiene derivatives, pyrene derivatives, bisstilbene derivatives and enamine derivatives. These charge transport substances can be used either singly or in combination.

Examples of the binder resin include thermoplastic or thermosetting resins, such as polystyrene, styrene-acrylonitrile copolymer, styrene-butadiene copolymer, styrene-maleic anhydride copolymer, polyester, polyvinyl chloride, vinyl chloride-vinyl acetate copolymer, polyvinyl acetate, polyvinylidene chloride, polyarlate, phenoxy resin, polycarbonate, cellulose acetate resin, ethyl cellulose resin, polyvinylbutyral, polyvinylformal, polyvinyltoluene, poly-N-vinylcarbazole, acrylic resin, silicone resin, epoxy resin, melamine resin, urethane resin, phenol resin and alkyd resin.

The amount of the charge transport substance is 20 parts by weight to 300 parts by weight, preferably 40 parts by weight to 150 parts by weight, based on 100 parts by weight of the binder resin. The thickness of the charge transport layer preferably ranges from 5 μm to 100 μm.

Examples of the solvent usable here include tetrahydrofuran, dioxane, toluene, dichloromethane, monochlorobenzene, dichloroethane, cyclohexanone, methyl ethyl ketone and acetone. Of these, use of non-halogen solvents is desirable in order to reduce a burden on environment. Specifically, cyclic ethers such as tetrahydrofuran, dioxolane and dioxane, aromatic hydrocarbons such as toluene and xylene and derivatives thereof are preferred.

As the charge transport layer, high molecular charge transport substances having both a function as a charge transport substance and a function as a binder resin are preferably employed. The charge transport layer composed of such a high molecular charge transport substance has excellent abrasion resistance. Known materials are usable as the high molecular charge transport substance, but polycarbonates having, in the main chain and/or side chain thereof, a triarylamine structure are preferred. Of these, high molecular charge transport substances represented by the formulas (I) to (X) are preferred. These substances and specific examples thereof will next be exemplified.

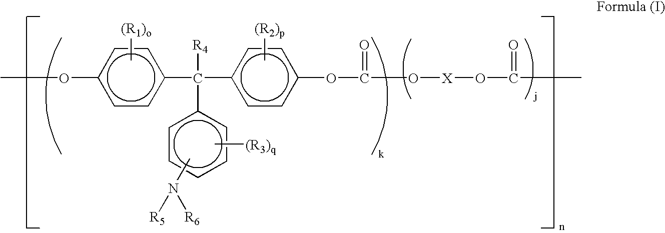

wherein R₁, R₂ and R₃ each independently represents a substituted or unsubstituted alkyl group, or a halogen atom, R₄ represents a hydrogen atom or a substituted or unsubstituted alkyl group, R₅ and R₆ each represents a substituted or unsubstituted aryl group, o, p and q each independently stands for an integer of 0 to 4, and k and j represents a composition ratio, with 0.1≦k≦1 and 0≦j≦0.9, n is the number of repeating units and stands for an integer of 5 to 5000, and X represents an aliphatic divalent group, a cycloaliphatic divalent group, or a divalent group represented by the following formula:

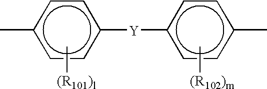

wherein R₁₀₁ and R₁₀₂ each independently represents a substituted or unsubstituted alkyl group or aryl group, or a halogen atom; l and m each stands for an integer of 0 to 4; and Y is a single bond, a linear, branched or cyclic C₁₋₁₂ alkylene group, —O—, —S—, —SO—, —SO₂—, —CO—, —CO—O—Z—O—CO— (in which Z represents an aliphatic divalent group), or

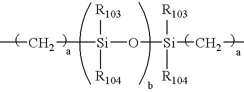

(in which a stands for an integer of 1 to 20, b stands for an integer of 1 to 2000, and R₁₀₃ and R₁₀₄ each represents a substituted or unsubstituted alkyl group or aryl group), with the proviso that R₁₀₁ and R₁₀₂ may be the same or different, and R₁₀₃ and R₁₀₄ may be the same or different.

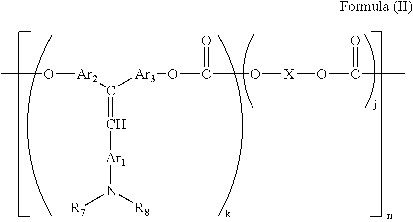

wherein R₇ and R₈ each represents a substituted or unsubstituted aryl group, Ar₁, Ar₂ and Ar₃ may be the same or different and represent an arylene group, and X, k, j and n have the same meanings as described in the formula (I).

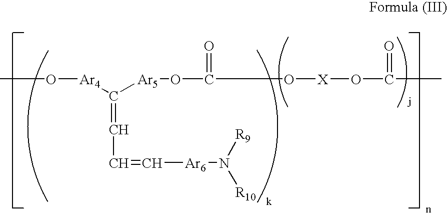

wherein R₉ and R₁₀ each represents a substituted or unsubstituted aryl group, Ar₄, Ar₅ and Ar₆ may be the same or different and represent an arylene group, and X, k, j and n have the same meanings as described above in the formula (I).

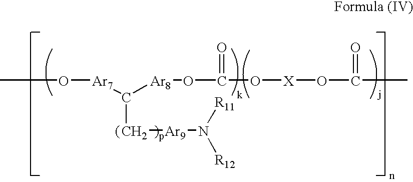

wherein R₁₁ and R₁₂ each represents a substituted or unsubstituted aryl group, Ar₇, Ar₈ and Ar₉ may be the same or different and represent an arylene group, p stands for an integer of 1 to 5, and X, k, j and n have the same meanings as described above in the formula (I).

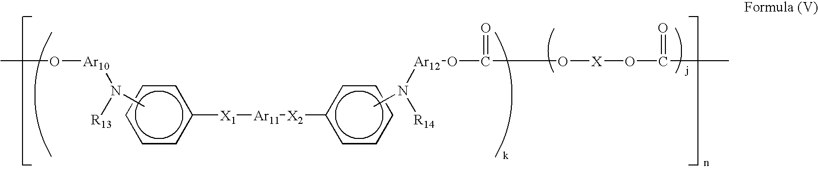

wherein R₁₃ and R₁₄ each represents a substituted or unsubstituted aryl group, Ar₁₀, Ar₁₁, and Ar₁₂ may be the same or different and represent an arylene group, X₁ and X₂ each represents a substituted or unsubstituted ethylene group or a substituted or unsubstituted vinylene group, and X, k, j and n have the same meanings as described above in the formula (I).

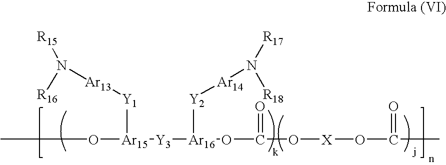

wherein R₁₅, R₁₆, R₁₇ and R₁₈ each represents a substituted or unsubstituted aryl group, Ar₁₃, Ar₁₄, Ar₁₅ and Ar₁₆ may be the same or different and represent an arylene group, Y₁, Y₂ and Y₃ each represents a single bond, a substituted or unsubstituted alkylene group, a substituted or unsubstituted cycloalkylene group, a substituted or unsubstituted alkylene ether group, an oxygen atom, a sulfur atom or a vinylene group and they may be the same or different, and X, k, j and n have the same meanings as described above in the formula (I).

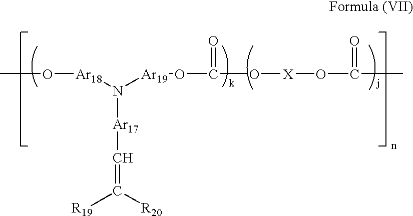

wherein R₁₉ and R₂₀ each represents a hydrogen atom or a substituted or unsubstituted aryl group, or R₁₉ and R₂₀ may form a ring, Ar₁₇, Ar₁₈ and Ar₁₉ are the same or different and represent an arylene group, and X, k, j and n have the same meanings as described above in the formula (I).

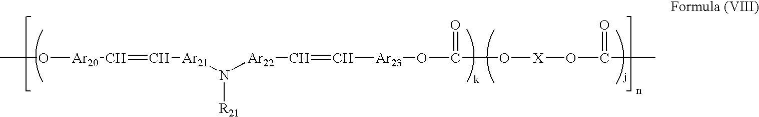

wherein R₂₁ represents a substituted or unsubstituted aryl group, Ar₂₀, Ar₂₁, Ar₂₂ and Ar₂₃ may be the same or different and represent an arylene group, and X, k, j and n have the same meanings as described above in the formula (I).

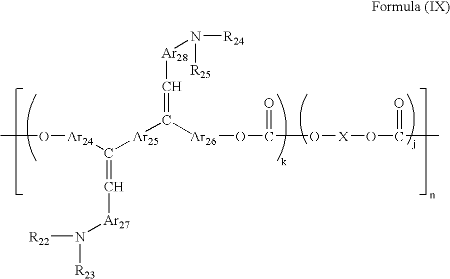

wherein R₂₂, R₂₃, R₂₄ and R₂₅ each represents a substituted or unsubstituted aryl group, Ar₂₄, Ar₂₅, Ar₂₆, Ar₂₇ and Ar₂₈ may be the same or different and represent an arylene group, and X, k, j and n have the same meanings as described above in the formula (I).

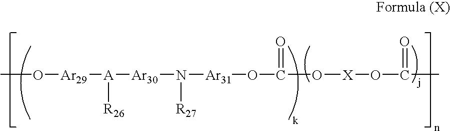

wherein R₂₆ and R₂₇ each represents a substituted or unsubstituted aryl group, Ar₂₉, Ar₃₀ and Ar₃₁ may be the same or different and represent an arylene group, and X, k, j and n have the same meanings as described above in the formula (I).

The high molecular charge transport substances to be used for the charge transport layer include, in addition to the above-described high molecular charge transport substances, polymers which are in the form of a monomer or oligomer having an electron donating group upon formation of the charge transport layer and have, in the end, a two dimensional or three dimensional crosslink structure by curing or crosslinking reaction after film formation.

The charge transport layer composed of such a polymer having an electron donating group or the polymer having a crosslink structure has excellent abrasion resistance. Generally in an electrophotographic process, since the charge potential (potential at an unexposed region) has a certain value, abrasion of the surface layer of the photoconductor after repeated use leads to an increase in electric field on the photoconductor. Since the occurring frequency of swear of the background increases with an increase in the strength of electric field, a high abrasion resistance of the photoconductor is advantageous against swear of the background. The charge transport layer composed of the polymer having an electron donating group has an excellent film forming property, because it is a high molecular compound by itself; and has excellent charge transport capacity, because it permits constitution of a charge transport portion with a high density compared with the charge transport layer composed of a low molecular dispersed type polymer. The photoconductor having a charge transport layer using a high molecular charge transport substance is expected to achieve high-speed response.

In addition, as the polymer having an electron donating group, usable are copolymers of a known monomer, block polymers, graft polymers, star polymers and crosslink polymers having an electron donating group as described, for example, in Japanese Patent Application Laid-Open (JP-A) Nos. 03-109406, 2000-206723 and 2001-34001.

In the present invention, the charge transport layer (37) may contain a plasticizer or a leveling agent. As the plasticizer, those ordinarily employed as a plasticizer for resins such as dibutyl phthalate and dioctyl phthalate are usable. It is preferably added in an amount of about 0% by weight to 30% by weight relative to the binder resin. Examples of the leveling agent include silicone oils such as dimethyl silicone oil and methyl phenyl silicone oil, and polymers or oligomers having a perfluoroalkyl group in their side chains. The leveling agent is preferably added in an amount of 0% by weight to 1% by weight relative to the binder resin.

In the electrophotographic photoconductor of the present invention, an intermediate layer can be disposed between the conductive support (31) and the photosensitive layer. The intermediate layer usually has a resin as a main component. In consideration that the resin has, formed thereon, the photosensitive layer by using a solvent, resins having a high resistance to the ordinarily employed solvents are desired. Such polymers include water soluble resins such as polyvinyl alcohol, casein and sodium polyacrylate, alcohol soluble resins such as copolymerized nylon and methoxymethylated nylon, and curable resins forming a three dimensional network structure such as polyurethane, melamine resin, phenol resin, alkyd-melamine resin and epoxy resin. To the intermediate layer, it is possible to add a fine powder pigment of a metal oxide such as titanium oxide, silica, alumina, zirconium oxide, tin oxide or indium oxide in order to prevent the Moire phenomenon and to reduce the residual potential.

The intermediate layer can be formed by using a proper solvent and a proper coating method as described above in the formation of the photosensitive layer. For the intermediate layer of the present invention, a silane coupling agent, titanium coupling agent or chromium coupling agent can be used. In addition, in the present invention, the intermediate layer obtained by anodization of Al₂O₃, or vacuum thin-film forming method using an organic material such as polyparaxylylene (parylene), or an inorganic material such as SiO₂, SnO₂, TiO₂, ITO or CeO₂ is preferred. The other known materials can also be employed. The thickness of the intermediate layer is suitably 0 to 5 μm.

In the electrophotographic photoconductor of the present invention, a protective layer may be disposed over the photosensitive layer to protect the photosensitive layer. In recent years, with wide spread of computers, printers are requested to attain high-speed output and size reduction. Owing to disposal of the protective layer for improving durability, the photoconductor of the present invention with high sensitivity and free of defects can be employed usefully.

In the photoconductor of the present invention, a protective layer (39) may be formed over the photosensitive layer in order to protect the photosensitive layer. Examples of the material used for the protective layer (39) include ABS resin, ACS resin, olefin-vinyl monomer copolymer, chlorinated polyether, allyl resin, phenol resin, polyacetal, polyamide, polyamideimide, polyacrylate, polyallylsulfone, polybutylene, polybutylene terephthalate, polycarbonate, polyarylate, polyether sulfone, polyethylene, polyethylene terephthalate, polyimide, acrylic resin, polymethylpentene, polypropylene, polyphenylene oxide, polysulfone, polystyrene, AS resin, butadiene-styrene copolymer, polyurethane, polyvinyl chloride, polyvinylidene chloride and epoxy resin. Of these, polycarbonate or polyarylate is most preferred.

To the protective layer, it is possible to add a fluorine resin such as polytetrafluoroethylene or silicone resin or the fluorine resin having, dispersed therein, an inorganic filler such as titanium oxide, tin oxide, potassium titanate or silica or an organic filler.

Among the filler materials used for the protective layer of the photoconductor, the organic filler materials include fluorine resin powder such as polytetrafluoroethylene, silicone resin powder and α-carbon powder. The inorganic filler materials include powder of a metal such as copper, tin, aluminum and indium, powder of a metal oxide such as silica, tin oxide, zinc oxide, titanium oxide, indium oxide, antimony oxide, bismuth oxide, tin oxide doped with antimony and indium oxide doped with tin, and potassium titanate. In particular, use of the inorganic material is advantageous from the viewpoint of the hardness of the filler, with silica, titanium oxide and alumina being effectively used.

The filler concentration in the protective layer differs, depending on the electrophotographic processing conditions under which the photoconductor is used. The filler concentration on the outermost layer side of the protective layer is 5% by weight or greater, preferably 10% by weight or greater, but 50% by weight or less, more preferably 20% by weight or less based on the total solid content.

The volume average particle diameter of the filler to be employed in the present invention preferably falls within a range of 0.1 μm to 2 μm. Excessively small average particle diameter disturbs sufficient exhibition of abrasion resistance, while excessively large average particle diameter deteriorates the surface of the film or disturbs formation of the film itself.

The term “average particle diameter” as used herein means a volume average particle diameter unless otherwise specifically indicated and it is determined by a ultra-centrifugal automatic particle size distribution analyzer “CAPA-700” (trade name; manufactured by HORIBA Ltd.). It is calculated as a particle diameter (median) corresponding to 50% of the cumulative distribution. It is important that the standard deviation of particles each measured simultaneously is 1 μm or less. When the standard deviation exceeds it, the particle size distribution becomes too large and a marked advantage of the present invention is not available.

The pH of the filler used in the present invention also has a great influence on the resolution or dispersibility of the filler. One of the reasons is that hydrochloric acid or the like may remain on the filler, especially the metal oxide filler, upon formation. If the residual amount is large, the occurrence of the image blur can not be prevented. The residual amount will also affect the dispersibility of the filler.

Another reason resides in a difference in the electrostatic property on the surface of the filler, especially on the metal oxide filler. Particles dispersed in a liquid usually have plus charges or minus charges. Ions having counter charges gather to keep electrical neutrality and there, an electric bilayer is formed, whereby the particles are able to have a stable state. The potential (Zeta potential) slowly decreases as the distance from the particles increases and it becomes zero in an electrically neutral region which is sufficiently distant from the particles. Accordingly, when the repulsive force between the particles becomes higher owing to an increase in the absolute value of the Zeta potential, the stability of the dispersion heightens, while when the potential approaches to zero, the particles tend to cause aggregation of the particles and the dispersion becomes unstable. On the other hand, the pH of the dispersion system causes a drastic change in the Zeta potential and at a certain pH, the potential becomes zero and an isoelectric point is formed. By setting the isoelectric point as far as that of the particles and heightening the absolute value of the Zeta potential, therefore, stabilization of the dispersion system can be attained.

In the constitution of the present invention, it has been confirmed that when the pH of the filler at an isoelectric point is 5 or greater, it is preferred from the viewpoint of preventing image blur, and the more basic the filler is, the higher effects it exhibits. Basic fillers exhibiting higher pH at an isoelectric point are able to have improved dispersibility and stability when the dispersion system is acidic, because the Zeta potential becomes high.

The pH of the filler in the present invention is the pH at an isoelectric point based on the Zeta potential. The Zeta potential is measured an electrophoretic light scattering spectrophotometer (product of Otsuka Electronics Co., Ltd.).

As a filler which does not easily cause image blur, those exhibiting high insulation (specific resistance: 10¹⁰ Ω·cm or greater) are preferred, with those having a pH of 5 or greater and those having a dielectric constant of 5 or greater being used especially effectively. Fillers having a pH of 5 or greater and those having a dielectric constant of 5 or greater may be used either singly or in combination as a mixture of two or more of them. Moreover, fillers having a dielectric constant of 5 or less and fillers having a dielectric constant of 5 or greater can be used in combination as a mixture of two or more of them. Of these fillers, α-alumina of a hexagonal close packed structure exhibiting high insulation, having high heat stability and moreover, having high abrasion resistance is particular effective from the viewpoints of prevention of image blur or improvement of abrasion resistance.

In this invention, the specific resistance of the filler is defined as follows. Powders such as filler differ in specific resistance depending on their filling ratio so that it must be measured under predetermined conditions. In the present invention, a measuring apparatus having a similar structure to that described in Japanese Patent Application Laid Open (JP-A) Nos. 05-94049 (FIG. 1) and 05-113688 (FIG. 1) was used for measuring the specific resistance of the filler and the values thus measured were used here. In the measuring apparatus, the electrode area is 4.0 cm². Prior to measurement, a load of 4 kg is applied to an electrode on one side for 1 minute and the amount of the sample is adjusted so that the distance of the electrodes will be 4 mm. Measurement is conducted while applying a load (1 kg) to the upper electrode and the applied voltage is 100V. In a region having a specific resistance of 106 Ω·cm, it was measured using HIGH RESISTANCE METER (product of Yokogawa HEWLETT PACKARD), while in a region having a specific resistance not exceeding 106 Ω·cm, a digital multimeter (Fluke) was employed for the measurement. The specific resistance thus determined serves as the specific resistance in the description of the present invention.

The dielectric constant of the filler was measured in the below-described manner. As in the above-described measurement of the specific resistance, a cell was used. After applying a load, a static capacitance was measured, from which a dielectric constant was determined. For the measurement of static capacitance, a dielectric loss measuring set (Ando Electric Co., Ltd.) was used.

The filler can be subjected to surface treatment with at least one surface treating agent and it is preferred to do so from the viewpoint of the dispersibility of the filler. Lowering in the dispersibility of the filler not only increases a residual potential but also lowers the transparency of the film, generates film defects and moreover lowers the abrasion resistance. This may lead to serious problems that disturb the achievement of high durability and high resolution. As the surface treating agent, any one conventionally used as the surface treating agent is usable, but those capable of keeping the insulation property of the filler are preferred. The surface treatment with a titanate coupling agent, aluminum coupling agent, zircoaluminate coupling agent or higher fatty acid; with the above-described agent in combination with a silane coupling agent; with Al₂O₃, TiO₂, ZrO₂, silicone or aluminum stearate; or with a mixture thereof is preferred in consideration of the dispersibility of the filler and image blur. The treatment only with a silane coupling agent has a strong influence on image blur, but the influence can sometimes be suppressed by the treatment with a mixture of the surface treatment agent and the silane coupling agent. Although the amount of the surface treatment varies, depending on the average primary particle size of the filler, it is preferably 3% by weight to 30% by weight, more preferably 5% by weight to 20% by weight. The surface treatment amount less than the above-described range is not effective for dispersing the filler, while the surface treatment amount exceeding the above-described range causes a drastic increase in the residual potential. These filler materials may be used either singly or in combination as a mixture. The surface treatment amount of the filler is defined as a weight ratio of the surface treating agent to the filler.

The filler material can be dispersed by using a suitable disperser. The filler is preferably dispersed to the level of primary particles and contains less aggregates from the viewpoint of the transmittance of the protective layer.

The protective layer (39) may contain a charge transport substance in order to reduce the residual potential and improve response. As the charge transport substance, materials as described in the explanation of the charge transport layer can be used. When a low-molecular charge transport substance is used as the charge transport substance, a concentration gradient may be disposed in the protective layer. A reduction in the concentration on the surface side is effective for improving abrasion resistance. The term “concentration” as used herein means a weight ratio of the low molecular charge transport substance to the total weight of all the materials constituting the protective layer. The term “concentration gradient” means a gradient of the concentration adjusted to be lower on the surface side at the above-described weight ratio. Use of a high molecular charge transport substance is considerably advantageous for heightening the durability of the photoconductor.

For the formation of the protective layer, the ordinarily employed coating method is employed. A suitable thickness of the protective layer is about 0.1 to 10 μm. Alternatively, known materials such as a-C and a-Si prepared by the vacuum thin-film forming method can be employed as the protective layer.

As described above, use of a high molecular charge transport substance for a photosensitive layer (charge transport layer) or disposal of a protective layer on the surface of the photoconductor not only heightens durability of each photoconductor (abrasion resistance) but also brings about new effects which are not produced in a monochrome image forming apparatus, when the photoconductor is used in a Tandem full-color image forming apparatus.

In the case of a full-color image, various types of images are usually input, but sometimes images of a predetermined pattern are input. A stamp of approval affixed on Japanese documents is one example of the predetermined pattern. The stamp of approval usually exists at the end side of the image region and colors used therefor are limited. When images are continuously written at random, image writing, development and transfer occur regularly on the photoconductor in the image forming element. When image formation in a specific part is repeated frequently as described above or only a specific image forming element is used, the photoconductor loses its durability balance. When a photoconductor having low surface durabilities (physical, chemical and mechanical) is used under such a state, a difference in the frequently used part and the other part becomes marked, causing a problem of images. Heightening of the durability of the photoconductor, on the other hand, lessens such a partial difference, and prevents easy appearance of it as an image defect. Achievement of high durability therefore improves the stability of an output image.

The process cartridge for electrophotographic apparatus according to the present invention is a detachable process cartridge used as a part of the electrophotographic apparatus of the present invention which process cartridge is formed integral therewith;

is equipped with an electrophotographic photoconductor and at least one unit selected from a charger, light irradiator, developer and cleaner,

is obtained by stacking at least a charge generation layer and a charge transport layer in this order over a conductive support, and the charge generation layer comprises titanyl phthalocyanine crystals having, as a diffraction peak (±0.2°) of Bragg angle 2θ with respect to the CuKα rays (wavelength: 1.542 angstrom), a maximum diffraction peak at at least 27.2°, having main peaks at 9.4°, 9.6° and 24.0°, having a peak at 7.3° as a diffraction peak on the lowest angle side, and not having a peak within a range of from 7.4 to 9.3°.

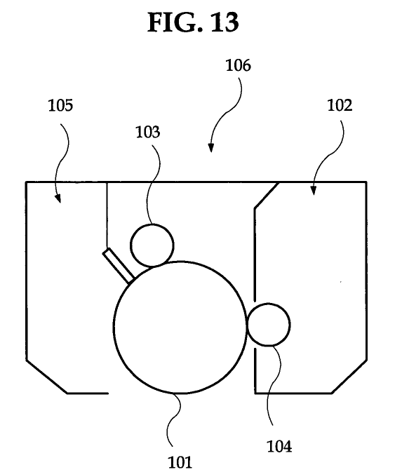

FIG. 13 is one constitution example of the process cartridge for electrophotographic apparatus according to the present invention and it has a photoconductor drum (101) as the above-described electrophotographic photoconductor, a charging roller (103) as the above-described charger, a cleaner (105) as the above-described cleaner and a developer (102) as the developer, each formed detachably as an integrated structure with the printer body. The developer (102) comprises a development sleeve (104).

The image forming process of the present invention comprises at least a step of charging an electrophotographic photoconductor,

exposing the electrophotographic photoconductor thus charged by the charging step in an image pattern, thereby forming an electrostatic latent image,

feeding a developing agent to the electrostatic latent image, thereby visualizing the electrostatic latent image and forming a toner image, and

transferring the toner image formed by the development step to a transfer material; wherein:

it takes 200 msec or less for the surface of the electrophotographic photoconductor exposed in the exposure step to reach the development step,

in the exposure step, the electrophotographic photoconductor is exposed to a write light having a resolution of 600 dpi or greater from the light irradiator so that the exposure energy will be 5 erg/cm² on the surface of the electrophotographic photoconductor, and

the electrophotographic photoconductor is obtained by stacking, over a conductive support, at least a charge generation layer and a charge transport layer in the order of mention, said charge generation layer comprising titanyl phthalocyanine crystals having, as a diffraction peak (±0.2°) of Bragg angle 2θ with respect to the CuKα rays (wavelength: 1.542 angstrom), a maximum diffraction peak at at least 27.2°, having main peaks at 9.4°, 9.6° and 24.0°, having a peak at 7.3° as a diffraction peak on the lowest angle side, and not having a peak within a range of from 7.4 to 9.3°.

The above-described image forming process can be carried out well by using the above-described electrophotographic apparatus of the present invention.

### EXAMPLES

The present invention will hereinafter be described by Examples. It should however be borne in mind that the present invention is not limited by them. In all the designations, “parts” means “parts by weight”.

First, synthesis examples of the titanyl phthalocyanine crystals (which may hereinafter be called “pigment”) used in the present invention will be described.

### Synthesis Example 1

To a mixture of 29.2 g of 1,3-diiminoisoindoline and 200 ml of sulfolane, 20.4 g of titanium tetrabutoxide was added dropwise under a nitrogen air stream. After completion of the dropwise addition, the temperature of the mixture was raised gradually to 180° C. While maintaining the reaction temperature within a range of from 170° C. to 180° C., reaction was effected by stirring for 5 hours. After completion of the reaction, the reaction mixture was allowed to cool down. The precipitate was collected by filtration, washed with chloroform until the powder became blue, washed several times with methanol, washed several times with hot water of 80° C., and dried, whereby crude titanyl phthalocyanine was obtained. The crude titanyl phthalocyanine thus obtained was dissolved in 20 times the amount of concentrated sulfuric acid. The resulting solution was added dropwise to 100 times the amount of ice water under stirring. The crystals thus precipitated were collected by filtration and washing with water was repeated until the washings became neutral, whereby the titanyl phthalocyanine pigment was obtained in the form of a wet cake. To 20 g of tetrahydrofuran was charged 2 g of the resulting wet cake, followed by stirring for 4 hours. The reaction mixture was filtered and dried, whereby titanyl phthalocyanine crystals to be used in the present invention were obtained.

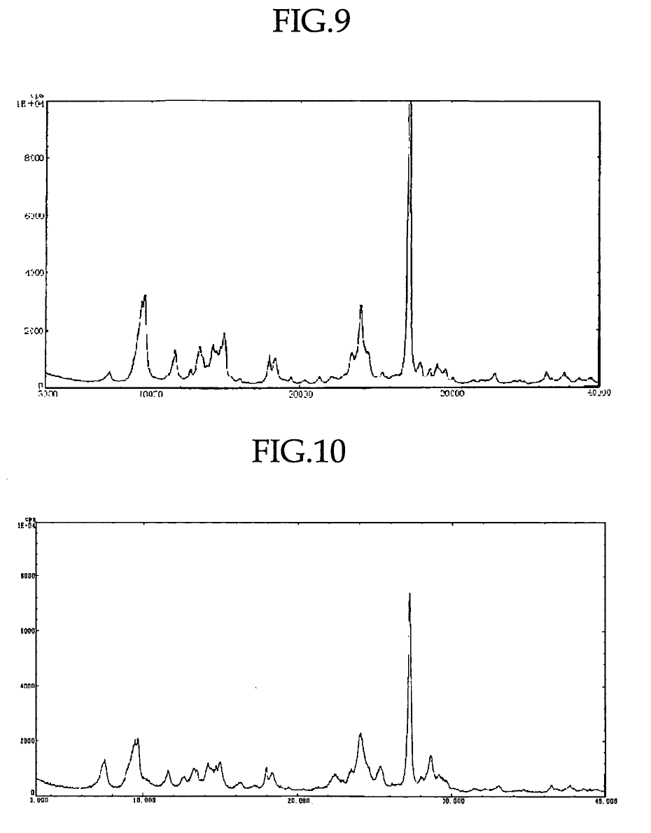

As a result of X-ray diffraction spectrum measurement under the below-described conditions, the resulting powder of titanyl phthalocyanine crystals had a maximum peak at Bragg angle 2θ of 27.2±0.2° with respect to Cu—Kα ray (wavelength: 1.542 angstrom), and a peak at the minimum angle of 7.3±0.2° and did not have a peak within a range of 7.4 to 9.3°. The results are shown in FIG. 9.

(X-ray Diffraction Spectrum Measuring Conditions)

X-ray tube: Cu

Voltage: 50 kV

Current: 30 mA

Scanning rate: 2°/min

Scanning range: 3° to 40°

Time constant: 2 sec

### Synthesis Example 2

In accordance with the process as described in Example 1 of Japanese Patent Application Laid-Open (JP-A) No. 01-299874 (Japanese Patent (JP-B) No. 2512081), a pigment was prepared. Described specifically, the wet cake prepared in Synthesis Example 1 was dried. After 1 g of the dried wet cake was added to 50 g of polyethylene glycol, the resulting mixture, together with 100 g of glass beads, was subjected to a sand mill treatment. After crystal transfer, the mixture was washed successively with dilute sulfuric acid and an aqueous aluminum hydroxide solution and then dried, whereby a pigment was obtained.

### Synthesis Example 3

In accordance with the process as described in Example 1 of Japanese Patent Application Laid-Open (JP-A) No. 03-269064 (Japanese Patent (JP-B) No. 2584682), a pigment was prepared. Described specifically, the wet cake prepared in Synthesis Example 1 was dried. After 1 g of the dried wet cake was stirred in a mixed solvent of 10 g of deionized water and 1 g of monochlorobenzene for 1 hour (50° C.), the reaction mixture was washed with methanol and deionized water, whereby a pigment was obtained.

### Synthesis Example 4

In accordance with the process as described in the Preparation Example of Japanese Patent Application Laid-Open (JP-A) No. 02-8256 (Japanese Patent Application Publication (JP-B) No. 07-91486), a pigment was prepared. Described specifically, 9.8 g of phthalodinitrile and 75 ml of 1-chloronaphthalene were mixed under stirring and 2.2 ml of titanium tetrachloride was added dropwise to the reaction mixture under a nitrogen gas stream. After completion of the dropwise addition, the temperature of the reaction mixture was raised gradually to 200° C. While keeping the reaction temperature within a range of from 200 to 220° C., the reaction was effected under stirring for 3 hours. After completion of the reaction, the reaction mixture was allowed to cool down. When the reaction mixture became 130° C., it was subjected to hot filtration. Then, washing was performed with 1-chloronaphthalene until the powder became blue, followed by washing several times with methanol. The powder was then washed several times with hot water of 80° C. and dried, whereby a pigment was obtained.

### Synthesis Example 5

In accordance with the process as described in Synthesis Example 1 of Japanese Patent Application Laid-Open (JP-A) No. 64-17066 (Japanese Patent Application Publication (JP-B) No. 07-97221), a pigment was prepared. Described specifically, crystal conversion treatment was conducted by subjecting 5 parts of α type TiOPc, together with 10 g of salt and 5 g of acetophenone, to sand grinder treatment at 100° C. for 10 hours. After washing with deionized water and methanol, the mixture was purified by an aqueous solution of dilute sulfuric acid. Washing with deionized water was continued until the acid content was eliminated. The residue was dried, whereby a pigment was obtained.

### Synthesis Example 6

In accordance with the process as described in Example 1 of Japanese Patent Application Laid-Open No. 11-5919 (Japanese Patent No. 3003664), a pigment was prepared. Described specifically, 20.4 parts of O-phthalodinitrile and 7.6 parts of titanium tetrachloride were reacted in 50 parts of quinoline under heating at 200° C. for 2 hours, followed by solvent removal by steam distillation. The residue was purified with a 2% aqueous solution of chloride and a 2% aqueous solution of sodium hydroxide, washed with methanol and N,N-dimethylformamide, and dried, whereby titanyl phthalocyanine was obtained. In 40 parts of 98% sulfuric acid at 5° C. was dissolved 2 parts of the resulting titanyl phthalocyanine in portions. The resulting solution was stirred for about 1 hour while maintaining the temperature at 5° C. or less. Then, the sulfuric acid solution was charged gradually to 400 parts of ice water subjected to high-speed stirring and the crystals thus precipitated were collected by filtration. The crystals were washed with distilled water until the acid was removed completely, whereby a wet cake was obtained. The resulting cake was stirred for 5 hours in 100 parts of THF. The resulting mixture was filtered, followed by washing with THF and drying, whereby a pigment was obtained.

### Synthesis Example 7

In accordance with the process as described in Synthesis Example 2 of Japanese Patent Application Laid-Open (JP-A) No. 03-255456 (Patent No. 3005052), a pigment was prepared. Described specifically, 10 parts of the wet cake prepared in Synthesis Example 1 was mixed with 15 parts of sodium chloride and 7 parts of diethylene glycol and the mixture was subjected to milling treatment in an automated mortar for 60 hours under heating at 80° C. Then the treated mixture was washed with water sufficiently in order to remove therefrom sodium chloride and diethylene glycol completely. After drying under reduced pressure, 200 parts of cyclohexanone and glass beads having a diameter of 1 mm were added. The mixture was treated in a sand mill for 30 minutes, whereby a pigment was obtained.

The X-ray diffraction spectrum of each of the pigments prepared in Synthesis Examples 2 to 7 was measured in a similar manner to that employed above and it was confirmed to be equal to that of the spectrum as described in each patent gazette. The characteristics of the peak position of the X-ray diffraction spectrum of these pigments and the pigment obtained in Synthesis Example 1 are shown in Table 1.

TABLE 1

| | Maximum | Minimum | | | Peak within a | Peak at |
|---|---|---|---|---|---|---|
| | peak | angle peak | Peak at 9.4° | Peak at 9.6° | range of 7.4 to 9.3° | 26.3° |
| Synthesis | 27.2 | 7.3° | Present | Present | Not present | Not |
| Example 1 | | | | | | present |
| Synthesis | 27.2 | 7.3° | Not | Not | Not present | Not |
| Example 2 | | | present | present | | present |
| Synthesis | 27.2 | 9.6° | Present | Present | Not present | Not |
| Example 3 | | | | | | present |
| Synthesis | 27.2 | 7.4° | Not | Present | Not present | Not |
| Example 4 | | | present | | | present |
| Synthesis | 27.2 | 7.3° | Present | Present | Present (7.5°) | Not |
| Example 5 | | | | | | present |
| Synthesis | 27.2 | 7.5° | Not | Present | Present (7.5°) | Not |
| Example 6 | | | present | | | present |
| Synthesis | 27.2 | 7.4° | Not | Not | Present | Present |
| Example 7 | | | present | present | (9.2°) | |

### Synthesis Example 8

To a mixture of 292 parts of 1,3-diiminoisoindoline and 1800 parts of sulfolane, 204 parts of titanium tetrabutoxide was added dropwise in a nitrogen gas stream. After completion of the dropwise addition, the temperature of the reaction mixture was raised gradually to 180° C. The reaction was effected by stirring for 5 hours while maintaining the reaction temperature within a range of from 170 to 180° C. After completion of the reaction, the reaction mixture was allowed to cool down and the precipitate was collected by filtration. It was washed with chloroform until the powder became blue, washed several times with methanol and washed several times with hot water of 80° C. and then dried, whereby crude titanyl phthalocyanine was obtained.

Of the crude titanyl phthalocyanine pigment thus obtained by hot water washing treatment, 60 parts of the pigment was dissolved in 1000 parts of 96% sulfuric acid under stirring at 3 to 5° C., followed by filtration. The sulfuric acid solution thus obtained was added dropwise to 35000 parts of ice water under stirring. The crystals thus precipitated were collected by filtration and washing with water was repeated until the washings became neutral, whereby the titanyl phthalocyanine pigment was obtained in the form of an aqueous paste.

To the resulting aqueous paste, 1500 parts of tetrahydrofuran was added and the mixture was vigorously stirred (at 2000 rpm) by a homomixer (“Mark IIf model”, Kenis Co., Ltd.) at room temperature. Stirring was terminated when the dark blue color of the paste changed to pale blue (20 minutes after stirring was started) and just after termination, filtration was conducted under reduced pressure. The crystals on the filtering apparatus were washed with tetrahydrofuran, whereby 98 parts of a pigment was obtained in the form of a wet cake. The wet cake was dried under reduced pressure (5 mmHg) at 70° C. for 2 days to yield 78 parts of titanyl phthalocyanine crystals.

The X-ray diffraction spectrum of the resulting titanyl phthalocyanine crystals were measured in a similar manner to that described above. As a result, it has been found that the spectrum was equal to that of the titanyl phthalocyanine crystals prepared in Synthesis Example 1.

### Photoconductor Manufacturing Example 1

On an aluminum cylinder (JIS1050) having a diameter of 60 mm, an undercoat layer coating solution, a charge generation layer coating solution, and a charge transport layer coating solution having the below-described compositions, respectively, were applied successively, followed by drying, whereby a laminated photoconductor (which will hereinafter be called “Photoconductor 1”) having the undercoat layer and charge generation layer, each having a thickness of 3.5 μm, and a charge transport layer having a thickness of 25 μm was manufactured. The thickness of the charge generation layer was adjusted so that the transmittance of the charge generation layer at 780 nm would be 20%. Under similar conditions to those employed for the manufacture of the photoconductor, a charge generation layer coating solution having the below-described composition was applied to an aluminum cylinder around which a polyethylene terephthalate film was wound. A polyethylene terephthalate film to which no charge generation layer had been applied was used as a control for comparison. Transmittance of them at 780 nm was evaluated by a commercially available spectrophotometer (“UV-3100”; product of Shimadzu Corporation).

Undercoat Layer Coating Solution

| | |
|---|---|
| Titanium oxide | 70 parts |
| (“CR-EL”; product of Ishihara Sangyo) | |
| Alkyd resin | 15 parts |
| [“Bekkolight M6401-50-S” (solid content: 50%, product of | |
| Dainippon Ink & Chemicals) | |
| Melamine resin | 10 parts |
| [“Superbeckamine L-121-60” (solid content: 60%, product | |
| of Dainippon Ink & Chemicals) | |
| 2-Butanone | 100 parts |

Charge Generation Layer Coating Solution

A dispersion having the below-described composition was prepared by beads milling under the below-described conditions.

| | |
|---|---|
| Titanyl phthalocyanine pigment | 15 parts |
| Prepared in Synthesis Example 1 | |
| Polyvinyl butyral | 10 parts |
| (“BX-1”, product of Sekisui Chemical) | |
| 2-Butanone | 280 parts |

In a commercially available beads mill dispersing machine were charged 2-butanone having polyvinyl butyral dissolved therein and the pigment and they were dispersed by using PSZ balls having a diameter of 0.5 mm for 30 minutes at a rotor rotation speed of 1500 rpm, whereby a dispersion was prepared.

The particle diameter of titanyl phthalocyanine crystals in the resulting dispersion was measured using “CAPA-700” (product of HORIBA, Ltd.). As a result, the average particle diameter was 0.25 μm.

Charge Transport Layer Coating Solution

| | |
|---|---|
| Polycarbonate (“TS2050”, product of | 10 parts |
| Teijin Chemical) | |
| Charge transport substance having | 7 parts |
| the below-described structural formula | |

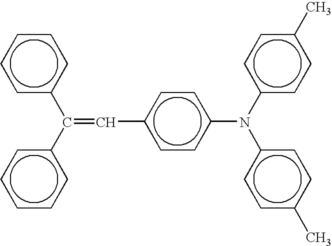

| | |
|---|---|
| Methylene chloride | 80 parts |

### Photoconductor Manufacturing Examples 2 to 7

In Manufacturing Examples 2 to 7, in a similar manner to that employed in Photoconductor Manufacturing Example 1 except that the titanyl phthalocyanine pigments prepared in Synthesis Examples 2 to 7 were used instead of the titanyl phthalocyanine pigment (prepared in Synthesis Example 1) used for the charge generation layer coating solution used in Photoconductor Manufacturing Example 1, photoconductors were manufactured, respectively. The thickness of each of the charge generation layers was adjusted as in Photoconductor Manufacturing Example 1 so that the transmittance, at 780 nm, of the charge generation layer prepared using the coating solution would be 20%.

The average particle diameter of the charge generation layer coating solutions used in Photoconductor Manufacturing Examples 2 to 7 was measured in a similar manner to that described above by using “CAPA-700” (product of HORIBA, Ltd.). As a result, an average particle diameter of each coating solution was as described below:

Manufacturing Example 2: 0.26 μm

Manufacturing Example 3: 0.30 μm

Manufacturing Example 4: 0.28 μm

Manufacturing Example 5: 0.24 μm

Manufacturing Example 6: 0.27 μm

Manufacturing Example 7: 0.24 μm

### Example 1 and Comparative Examples 1 to 13

The electrophotographic photoconductors thus obtained in Photoconductor Manufacturing Examples 1 to 7 were each loaded on the electrophotographic apparatus (150 msec between exposure-development) as illustrated in FIG. 1. A semiconductor laser of 780 nm was used as a light source for the image exposure (image writing by a polygon mirror) and the image was written at a resolution of 600 dpi. As the charging member, a contact type charging roller was used and under the below-described charging and exposure conditions, an image of 1 dot line and solid image were output. At the same time, the surface potential of the photoconductor was measured using a jig permitting setting of a potentiometer at the position where a developer was to be installed in order to measure the surface potentials (at an unexposed portion and image exposed portion) of the photoconductor at the position of a development portion. Upon measurement of the potential at the exposed portion, surface potential when solid writing was conducted at a predetermined light amount was measured. The results are shown in Table 2.

<Charging Conditions>

DC bias: −900V

AC bias: 2.0 kV (peak to peak), frequency: 1.5 kHz

<Image Exposure Conditions>

Two conditions of 4.5 erg./cm² and 6.0 erg./cm² as an exposure energy on the surface of a photoconductor.

TABLE 2

| | | | Light | Potential at | Potential at | |
|---|---|---|---|---|---|---|
| | | | exposure | unexposed | exposed | Evaluation of |
| | Photoconductor | Pigment | (erg./cm²) | part (−V) | part (−V) | image |
| Ex. 1 | Manufacturing | Synthesis | 4.5 | 900 | 110 | Good |
| | Example 1 | Example 1 | | | | |
| Comp. | Manufacturing | Synthesis | 4.5 | 900 | 170 | Lowering of |
| Ex. 1 | Example 2 | Example 2 | | | | image density |
| Comp. | Manufacturing | Synthesis | 4.5 | 900 | 150 | Lowering of |
| Ex. 2 | Example 3 | Example 3 | | | | image density |
| Comp. | Manufacturing | Synthesis | 4.5 | 900 | 160 | Lowering of |
| Ex. 3 | Example 4 | Example 4 | | | | image density |
| Comp. | Manufacturing | Synthesis | 4.5 | 900 | 140 | Lowering of |
| Ex. 4 | Example 5 | Example 5 | | | | image density |
| Comp. | Manufacturing | Synthesis | 4.5 | 900 | 160 | Lowering of |
| Ex. 5 | Example 6 | Example 6 | | | | image density |
| Comp. | Manufacturing | Synthesis | 4.5 | 900 | 150 | Lowering of |
| Ex. 6 | Example 7 | Example 7 | | | | image density |
| Comp. | Manufacturing | Synthesis | 6.0 | 900 | 110 | Line |
| Ex. 7 | Example 1 | Example 1 | | | | thickening |
| Comp. | Manufacturing | Synthesis | 6.0 | 900 | 140 | Line |
| Ex. 8 | Example 2 | Example 2 | | | | thickening |
| Comp. | Manufacturing | Synthesis | 6.0 | 900 | 130 | Line |
| Ex. 9 | Example 3 | Example 3 | | | | thickening |
| Comp. | Manufacturing | Synthesis | 6.0 | 900 | 130 | Line |
| Ex. 10 | Example 4 | Example 4 | | | | thickening |
| Comp. | Manufacturing | Synthesis | 6.0 | 900 | 120 | Line |
| Ex. 11 | Example 5 | Example 5 | | | | thickening |
| Comp. | Manufacturing | Synthesis | 6.0 | 900 | 140 | Line |
| Ex. 12 | Example 6 | Example 6 | | | | thickening |
| Comp. | Manufacturing | Synthesis | 6.0 | 900 | 130 | Line |
| Ex. 13 | Example 7 | Example 7 | | | | thickening |

### Photoconductor Manufacturing Example 8

In a similar manner to that employed in Photoconductor Manufacturing Example 1 except for the use of a charge transport layer coating solution having the below-described composition instead of that obtained in Photoconductor Manufacturing Example 1, a photoconductor was manufactured.

Charge Transport Layer Coating Solution

| | | |
|---|---|---|
| High molecular charge transport substance | 10 | parts |
| having the below-described composition | | |
| (weight average molecular weight: about | | |
| 135000) | | |

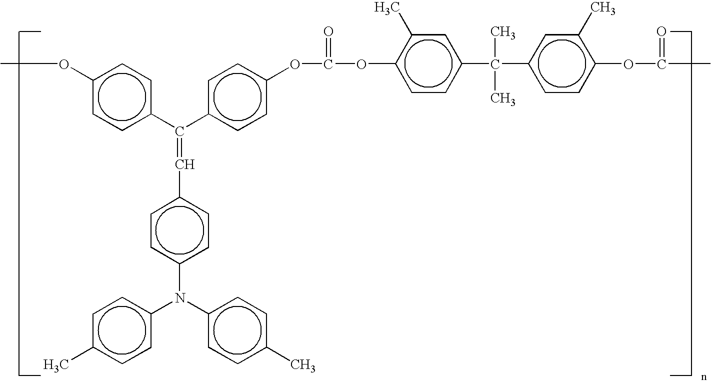

| | | |
|---|---|---|
| Additive of the below-described structure | 0.5 | part |

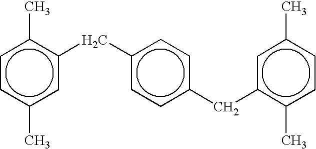

| | | |
|---|---|---|
| Methylene chloride | 100 | parts |

### Photoconductor Manufacturing Example 9

In a similar manner to that employed for Photoconductor Manufacturing Example 1 except that the thickness of the charge transport layer was adjusted to 20 μm, and a protective layer having a thickness of 5 μm was disposed by applying a protective layer coating solution having the below-described composition onto the charge transport layer and then drying, a photoconductor was manufactured.

Protective Layer Coating Solution

| | |
|---|---|
| Polycarbonate (“TS2050”: product of Teijin Chemical) | 10 parts |
| Charge transport substance having the | 7 parts |
| below-described structural formula | |

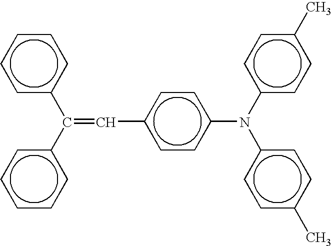

| | |
|---|---|
| Fine alumina particles (specific resistance: | 4 parts |
| 2.5 × 10¹² Ω · cm, average particle diameter: | |
| 0.4 μm) | |
| Cyclohexanone | 500 parts |
| Tetrahydrofuran | 150 parts |

### Photoconductor Manufacturing Example 10

In a similar manner to that employed in Photoconductor Manufacturing Example 9 except that fine alumina particles in the protective layer coating solution were changed to the below-described ones, a photoconductor was manufactured.

| | |
|---|---|
| Titanium oxide fine particles | 4 parts |
| (specific resistance: 1.5 × 10¹⁰ Ω · cm, average primary particle | |
| diameter: 0.5 μm) | |

### Photoconductor Manufacturing Example 11

In a similar manner to that employed in Photoconductor Manufacturing Example 9 except that the fine alumina particles in the protective layer coating solution were changed to the below-described ones, a photoconductor was manufactured.

| | |
|---|---|
| Tin oxide - antimony oxide powder | 4 parts |
| (specific resistance: 10⁶ Ω · cm, average primary particle | |
| diameter: 0.4 μm) | |

### Photoconductor Manufacturing Example 12

In a similar manner to that employed in Photoconductor Manufacturing Example 1 except that the aluminum cylinder (JIS1050) used in Photoconductor Manufacturing Example 1 was subjected to anodizing treatment as described below and a charge generation layer and a charge transport layer were disposed without disposing the undercoat layer, a photoconductor was manufactured.

Anodizing Coating Treatment

After the surface of the support was mirror finished, washed for degreasing, and then washed with water, the resulting support was immersed in an electrolytic bath containing 15 vol. % of sulfuric acid at a liquid temperature of 20° C. and anodizing coating treatment was carried out at an electrolytic voltage of 15V for 30 minutes. After washing with water further, the support was subjected to sealing treatment with a 7% aqueous solution of nickel acetate (50° C.). Then, the support was washed with pure water, whereby the support having an anodic oxide coating having a thickness of 7 μm formed thereon was obtained.

### Photoconductor Manufacturing Example 13

In a similar manner to that employed for Photoconductor Manufacturing Example 1 except for the use of titanyl phthalocyanine crystals prepared in Synthesis Example 8 instead of those prepared in Synthesis Example 1, a photoconductor was manufactured. The average particle diameter of the charge generation layer coating solution using the pigment of Synthesis Example 8 was 0.20 μm.

### Photoconductor Manufacturing Example 14

In a similar manner to that employed in Photoconductor Manufacturing Example 1 except for the use of the below-described charge generation layer coating solution instead, a photoconductor was manufactured.

Charge Generation Layer Coating Solution

The dispersion having the below-described composition was prepared by beads milling under the below-described conditions.

| | |
|---|---|
| Titanyl phthalocyanine pigment prepared in | 15 parts |
| Synthesis Example 1 | |
| Polyvinyl butyral (“BX-1”, product of | 10 parts |
| Sekisui Chemical) | |
| 2-Butanone | 280 parts |

In a commercially available beads mill dispersing machine were charged 2-butanone having polyvinyl butyral dissolved therein and the pigment and they were dispersed by using PSZ balls having a diameter of 0.5 mm for 30 minutes at a rotor rotation speed of 1500 rpm, whereby a dispersion was prepared. The dispersion was taken out from the beads mill apparatus and filtered using a cotton wind cartridge filter “TCW-3-CS” (product of Advantech, effective pore size: 3 μm). The filtration was carried out using a pump under pressure.

The particle diameter of the titanyl phthalocyanine crystals in the dispersion thus prepared was measured by “CAPA-700” (product of HORIBA, Ltd.). As a result, an average particle diameter was 0.24 μm.

The charge generation layer coating solution used in Photoconductor Manufacturing Example 14 and the charge generation layer coating solution used in Photoconductor Manufacturing Example 1 were applied onto a slide glass with a small thickness and the state of the film was observed by an optical microscope (500-fold). As a result, slight existence of coarse particles was recognized in the charge generation layer coating solution used in Photoconductor Manufacturing Example 1, but existence of coarse particles was not recognized in the charge generation layer coating solution used in Photoconductor Manufacturing Example 14.

### Examples 2 to 9 and Comparative Examples 14 to 19

The electrophotographic photoconductors of Photoconductor Manufacturing Examples 1 to 14 manufactured as described above were installed on the electrophotographic apparatus (distance between exposure and development: 150 msec) as illustrated in FIG. 1 and writing was performed at a resolution of 600 dpi by using a semiconductor laser of 780 nm (image writing by a polygon mirror) as an image light source for writing. By using, as a charging member, that for close disposal as illustrated in FIG. 2 with a 50-μm thick insulating tape wound at both ends of a charging roller, 50,000 sheets of a chart having a writing ratio of 6% was printed continuously under the below-described charging and exposure conditions. The image at the beginning and after printing of 50000 sheets were evaluated (running environment: 22° C.-55% RH). A white solid image was output at the beginning and after 50000 sheets printing, and the greasing (the below-described rank) was evaluated. In addition, after printing of 50000 sheets, a halftone image was output and image blur was evaluated. The abrasion amount (when the photoconductor has a protective layer, its means the abrasion amount of the protective layer) on the surface of the photoconductor was measured after output of 50000 sheets. The results are shown in Table 3.

<Charging Conditions>

DC bias: −900V

AC bias: 2.0 kV (peak to peak), frequency: 1.5 kHz

<Image Exposing Conditions>

The surface of the photoconductor was exposed to a light of 4.5 erg./cm² as an exposure energy.

TABLE 3

| | | Greasing | | | Abrasion |
|---|---|---|---|---|---|
| | | | After printing | Halftone | amount |
| | Photoconductor | Beginning | 50000 sheets | image | (μm) |
| Ex. 2 | Manufacturing | 5 | 3-4 | Good | 2.8 |
| | Ex. 1 | | | | |
| Comp. Ex. 14 | Manufacturing | 3 | 2 or less | Lowering in | 2.8 |
| | Ex. 2 | | | image density | |
| Comp. Ex. 15 | Manufacturing | 3 | 2 or less | Lowering in | 2.8 |
| | Ex. 3 | | | image density | |
| Comp. Ex. 16 | Manufacturing | 3 | 2 or less | Lowering in | 2.8 |
| | Ex. 4 | | | image density | |
| Comp. Ex. 17 | Manufacturing | 3-4 | 2 or less | Lowering in | 2.8 |
| | Ex. 5 | | | image density | |
| Comp. Ex. 18 | Manufacturing | 3-4 | 2 or less | Lowering in | 2.8 |
| | Ex. 6 | | | image density | |
| Comp. Ex. 19 | Manufacturing | 3 | 2 or less | Lowering in | 2.8 |
| | Ex. 7 | | | image density | |
| Ex. 3 | Manufacturing | 5 | 4 | Good | 1.7 |
| | Ex. 8 | | | | |
| Ex. 4 | Manufacturing | 5 | 4 to 5 | Good | 1.3 |
| | Ex. 9 | | | | |
| Ex. 5 | Manufacturing | 5 | 4 to 5 | Good | 1.1 |
| | Ex. 10 | | | | |
| Ex. 6 | Manufacturing | 5 | 4 | Slight image | 1.3 |
| | Ex. 11 | | | blur occurred | |
| Ex. 7 | Manufacturing | 5 | 5 | Good | 2.8 |
| | Ex. 12 | | | | |
| Ex. 8 | Manufacturing | 5 | 4 to 5 | Good | 2.8 |
| | Ex. 13 | | | | |
| Ex. 9 | Manufacturing | 5 | 5 | Good | 2.8 |
| | Ex. 14 | | | | |

As a result of enlarged observation of the halftone image of each of Example 2, 8 and 9, the image of each of Example 8 and Example 9 had a dot with a clear profile compared with that of Example 2.

<Rank of Greasing>

5: Almost free of greasing

4: Slight greasing,

3: limit of practical usable level

2 or less: level not permitting practical use

### Examples 10 to 11, and Comparative Examples 20 to 21

In a similar manner to Example 1 except that the photoconductor obtained in Photoconductor Manufacturing Example 1 or 14 was used, the optical system of the apparatus was changed, and writing was performed at 1200 dpi or 400 dpi (under the two conditions of the light exposure of 4.5 erg./cm² and 6.0 erg./cm²), the image was evaluated. The results are shown in Table 4.

TABLE 4

| | | | Resolution | |
|---|---|---|---|---|
| | | Light exposure | upon writing | |
| | Photoconductor | (erg/cm²) | (dpi) | Evaluation of image |
| Comp. Ex. 20 | Manufacturing Ex. 1 | 4.5 | 400 | Lowering of resolution |
| Ex. 10 | Manufacturing Ex. 1 | 4.5 | 1200 | Good |
| Comp. Ex. 21 | Manufacturing Ex. 1 | 6.0 | 400 | Thickening of line |
| Comp. Ex. 22 | Manufacturing Ex. 1 | 6.0 | 1200 | Thickening of line |
| Comp. Ex. 23 | Manufacturing Ex. 14 | 4.5 | 400 | Lowering of resolution |
| Ex. 11 | Manufacturing Ex. 14 | 4.5 | 1200 | Good |
| Comp. Ex. 24 | Manufacturing Ex. 14 | 6.0 | 400 | Thickening of line |
| Comp. Ex. 25 | Manufacturing Ex. 14 | 6.0 | 1200 | Thickening of line |

The resolution of the image written at 400 dpi was lower than that of the image written at 600 dpi (Example 1). In particular, this tendency was marked in the case of Comparative Example 23 compared with Comparative Example 20. The image obtained by writing at 1200 dpi was better than that obtained by writing at 600 dpi. This tendency was marked in Example 11 than Example 10. The line thickening occurred whenever the light exposure was 6.0 erg/cm², but a change was smaller when the photoconductor of Manufacturing Example 14 was used than when the photoconductor of Manufacturing Example 1 was used.

### Example 12

After running test of 50000 sheets in Example 2, one dot image was output under the circumstances of 30° C. and 90% RH and the image was evaluated.

### Example 13

The charging member was changed from that for close disposal used in Example 2 to a scorotron charger and the surface potential of a non-image portion of the photoconductor was set equal to that of Example 2 (−900V). In a similar manner to Example 2 without changing the other conditions, a running test of 50000 sheets was conducted. After the running test, one dot image was output under the circumstances of 30° C. and 90% RH and the image was evaluated as in Example 12.

### Example 14

The charging member was changed from that for close disposal used in Example 2 to a contact type charging member (without a gap) and charging conditions were set equal to those of Example 2. In a similar manner to Example 2 without changing the other conditions, a running test of 50000 sheets was conducted. After the running test, one dot image was output under the circumstances of 30° C. and 90% RH and the image was evaluated as in Example 12.

### Example 15

In a similar manner to Example 14 except for the charging conditions were changed as described below, evaluation was conducted.

<Charging Conditions>

DC bias: −1600V (surface potential at a non-image portion of the photoconductor under the initial state was −900V)

AC bias: none

### Example 16

In a similar manner to Example 2 except for the charging conditions were changed as described below, evaluation was conducted. After the running test of 50000 sheets, one dot image was output under the circumstances of 30° C. and 90% RH and the image was evaluated as in Example 12.

<Charging Conditions>

DC bias: −1600V (surface potential at a non-image portion of the photoconductor under the initial state was −900V)

AC bias: none

### Example 17

In a similar manner to Example 2 except for the gap of the charging member (closely disposed charging roller) was changed to 100 μm, evaluation was conducted. After the running test of 50000 sheets, one dot image was output under the circumstances of 30° C. and 90% RH and the image was evaluated as in Example 12.

### Example 18

In a similar manner to Example 2 except for the gap of the charging member (closely disposed charging roller) used in Example 2 was changed to 150 μm, evaluation was conducted. After the running test of 50000 sheets, one dot image was output under the circumstances of 30° C. and 90% RH and the image was evaluated as in Example 12.

### Example 19

In a similar manner to Example 8 except for the gap of the charging member (closely disposed charging roller) used in Example 8 was changed to 250 μm, evaluation was conducted. After the running test of 50000 sheets, one dot image was output under the circumstances of 30° C. and 90% RH and the image was evaluated as in Example 12.

The above-descried evaluation results in Examples 12 to 19 are shown in Table 5.

TABLE 5

| | Halftone image | | | |
|---|---|---|---|---|
| | Begin- | After printing | Halftone image | |
| | ning | of 50000 sheets | (30° C., 90% RH) | Remarks |
| Ex. 12 | Good | Good | Good | |
| Ex. 13 | Good | Slight blurring | Slight blurring | Severe ozone |
| | | of image | of image | odor during |
| | | | | running |
| Ex. 14 | Good | Slight blurring | Slight blurring | Stain on charging |
| | | of image | of image density | roller |
| | | density | | |
| Ex. 15 | Good | Slight blurring | Slight blurring | Stain on charging |
| | | of image | of image density | roller |
| | | density | | |
| Ex. 16 | Good | Slight blurring | Slight blurring | |
| | | of image | of image density | |
| | | density | | |
| Ex. 17 | Good | Good | Good | |
| Ex. 18 | Good | Good | Good | |
| Ex. 19 | Good | Slight blurring | Slight blurring | |
| | | of image | of image density | |
| | | density | | |

### Photoconductor Manufacturing Example 15

In a similar manner to Photoconductor Manufacturing Example 1 except that the charge transport layer coating solution was changed to that having the below-described composition, a photoconductor was manufactured.

Charge Transport Layer Coating Solution

| | |
|---|---|
| Polycarbonate (“TS2050”; product of | 10 parts |
| Teijin Chemical) | |
| Charge transport substance having the | 7 parts |
| below-described formula | |

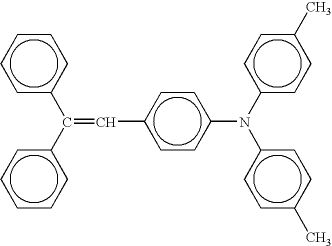

| | |
|---|---|
| Tetrahydrofuran | 80 parts |

### Photoconductor Manufacturing Example 16

In a similar manner to Photoconductor Manufacturing Example 6 except that the charge transport layer coating solution was changed to that having the below-described composition, a photoconductor was manufactured.

Charge Transport Coating Solution

| | |
|---|---|
| Polycarbonate (“TS2050”; product of | 10 parts |
| Teijin Chemical) | |
| Charge transport substance having the | 7 parts |
| below-described formula | |

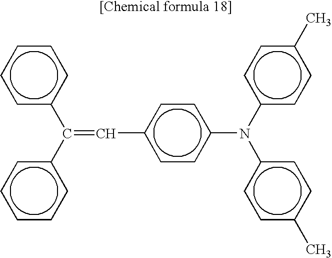

| | |
|---|---|
| Tetrahydrofuran | 80 parts |

### Photoconductor Manufacturing Example 17

In a similar manner to Photoconductor Manufacturing Example 1 except for the use of the charge transport layer coating solution having the below-described composition instead, a photoconductor was manufactured.

Charge Transport Coating Solution

| | |
|---|---|
| Polycarbonate (“TS2050”; product of | 10 parts |
| Teijin Chemical) | |
| Charge transport substance having the | 7 parts |
| below-described formula | |

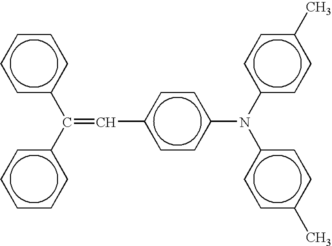

| | |
|---|---|
| Dioxolane | 80 parts |

### Photoconductor Manufacturing Example 18

In a similar manner to Photoconductor Manufacturing Example 1 except for the use of the charge transport layer coating solution having the below-described composition instead, a photoconductor was manufactured.

Charge Transport Layer Coating Solution

| | |
|---|---|
| Polycarbonate (“TS2050”; product of | 10 parts |
| Teijin Chemical) | |
| Charge transport substance having the | 7 parts |
| below-described formula | |

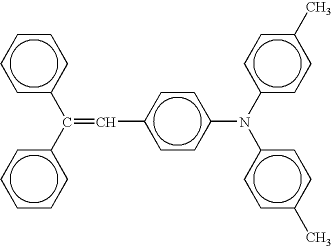

| | |
|---|---|
| Tetrahydrofuran | 40 parts |
| Toluene | 40 parts |

### Examples 20 to 22, and Comparative Example 26

The electrophotographic photoconductors thus obtained in Photoconductor Manufacturing Examples 15 to 18 were each loaded on an electrophotographic apparatus (150 msec between exposure-development) as illustrated in FIG. 1. A semiconductor laser of 780 nm was used as a light source for image exposure (image writing by a polygon mirror) and the image was written at a resolution of 600 dpi. As the charging member, a contact type charging roller was used and under the below-described charging and exposure conditions, an image of 1 dot line and solid image were output. At the same time, the surface potential of the photoconductor was measured using a jig permitting setting of a potentiometer at the position where a developer was to be installed in order to measure the surface potentials (at an unexposed portion and image exposed portion) of the photoconductor at the position of a development portion. Upon measurement of the potential at the exposed portion, surface potential when solid writing was conducted at a predetermined light amount was measured. The above-described results are shown, together with the results of Example 1 and Comparative Example 5, in Table 6.

<Charging Conditions>

DC bias: −900V

AC bias: 2.0 kV (peak to peak), frequency: 1.5 kHz

<Image Exposure Conditions>

4.5 erg./cm² as an exposure energy on the surface of the photoconductor

TABLE 6

| | | | Light | Potential of | Potential of | |
|---|---|---|---|---|---|---|
| | | | exposure | unexposed | exposed | Evaluation of |
| | Photoconductor | Pigment | (erg./cm²) | portion (−V) | portion (−V) | image |
| Ex. 1 | Manufacturing | Synthesis Ex. 1 | 4.5 | 900 | 110 | Good |
| | Ex. 1 | | | | | |
| Ex. 20 | Manufacturing | Synthesis Ex. 1 | 4.5 | 900 | 130 | Good |
| | Ex. 15 | | | | | |
| Ex. 21 | Manufacturing | Synthesis Ex. 1 | 4.5 | 900 | 120 | Good |
| | Ex. 17 | | | | | |
| Ex. 22 | Manufacturing | Synthesis Ex. 1 | 4.5 | 900 | 120 | Good |
| | Ex. 18 | | | | | |
| Comp. | Manufacturing | Synthesis Ex. 6 | 4.5 | 900 | 160 | Lowering in |
| Ex. 5 | Ex. 6 | | | | | image density |
| Comp. | Manufacturing | Synthesis Ex. 6 | 4.5 | 900 | 210 | Lowering in |
| Ex. 26 | Ex. 16 | | | | | image density |

### Photoconductor Manufacturing Example 19

In a similar manner to Photoconductor Manufacturing Example 1 except for the use of an aluminum cylinder having a diameter of 30 mm instead, a photoconductor was manufactured.

### Photoconductor Manufacturing Example 20

In a similar manner to Photoconductor Manufacturing Example 4 except for the use of an aluminum cylinder having a diameter of 30 mm instead, a photoconductor was manufactured.

### Photoconductor Manufacturing Example 21

In a similar manner to Photoconductor Manufacturing Example 5 except for the use of an aluminum cylinder having a diameter of 30 mm instead, a photoconductor was manufactured.

### Example 23 and Comparative Examples 27 to 31

The photoconductors thus obtained in Photoconductor Manufacturing Examples 19 to 21 were each installed, together with a charging member, on one process cartridge for electrophotographic apparatus and the resulting cartridge was installed on a full-color electrophotographic apparatus (distance between exposure and development: 100 msec) as illustrated in FIG. 5. Under the below-described processing conditions for four image forming elements, the full-color image of 20000 sheets was evaluated. A white solid image and full-color image were evaluated at the beginning and after printing of 20000 sheets. In addition, the surface potential of an image portion at black developed part and non-image portion were evaluated as in Example 1. The results are shown in Table 7.

<Charging Conditions>

DC bias: −800V,

AC bias: 1.5 kV (peak to peak),

Frequency: 2.0 kHz

<Charging Member>

similar to that used in Example 2

<Writing>

Writing: under an LD (using a polygon mirror) of 780 nm at resolution of 1200 dpi

<Light Amount>

Two conditions, that is, 4.5 erg./cm² and 6.0 erg./cm² as an exposure energy on the surface of a photoconductor

TABLE 7

| | | | | | | At the beginning of | | After printing of 20000 | | |
|---|---|---|---|---|---|---|---|---|---|---|
| | | | | Greasing rank | | printing | | sheets | | |
| | | | Light | Be- | After | Potential at | Potential at | Potential at | Potential at | |
| | | | exposure | gin- | printing of | unexposed | exposed | unexposed | exposed | |
| | Photoconductor | Pigment | (erg/cm²) | ning | 20000 sheets | portion (−V) | portion (−V) | portion (−V) | portion (−V) | Image |
| Ex. 23 | Manufacturing | Synthesis | 4.5 | 5 | 4 | 800 | 110 | 790 | 120 | Good |
| | Ex. 19 | Ex. 1 | | | | | | | | |
| Comp. | Manufacturing | Synthesis | 4.5 | 3 | 2 or less | 800 | 135 | 760 | 160 | Deterioration in |
| Ex. 27 | Ex. 20 | Ex. 4 | | | | | | | | color reproduction |
| Comp. | Manufacturing | Synthesis | 4.5 | 3 to 4 | 2 or less | 800 | 150 | 780 | 180 | Deterioration in |
| Ex. 28 | Ex. 21 | Ex. 5 | | | | | | | | color reproduction |
| Comp. | Manufacturing | Synthesis | 6.0 | 5 | 4 | 800 | 110 | 780 | 130 | Line thickening |
| Ex. 29 | Ex. 19 | Ex. 1 | | | | | | | | |
| Comp. | Manufacturing | Synthesis | 6.0 | 3 | 2 or less | 800 | 125 | 740 | 180 | Line thickening, |
| Ex. 30 | Ex. 20 | Ex. 4 | | | | | | | | deterioration in |
| | | | | | | | | | | color reproduction |
| Comp. | Manufacturing | Synthesis | 6.0 | 3 to 4 | 2 or less | 800 | 140 | 750 | 200 | Line thickening, |
| Ex. 31 | Ex. 21 | Ex. 5 | | | | | | | | deterioration in |
| | | | | | | | | | | color reproduction |

In the end, it will be examined whether or not the lowest angle peak 7.3° of Bragg angle θ, which is a characteristic of the titanyl phthalocyanine crystals used in the present invention is equal to the lowest angle 7.5° of the known material.

### Synthesis Example 9

In a similar manner to Synthesis Example 1 except for the use of 2-butanone instead of methylene chloride as the crystal converting solvent, titanyl phthalocyanine crystals were obtained.

As in FIG. 9, the XD spectrum of the titanyl phthalocyanine crystals prepared in Synthesis Example 9 was measured and shown in FIG. 10. From FIG. 10, it has been understood that the lowest angle in the XD spectrum of the titanyl phthalocyanine crystals prepared in Synthesis Example 9 existed at 7.5° different from the lowest angle (7.3°) of the titanyl phthalocyanine prepared in Synthesis Example 1.

### Measurement Example 1

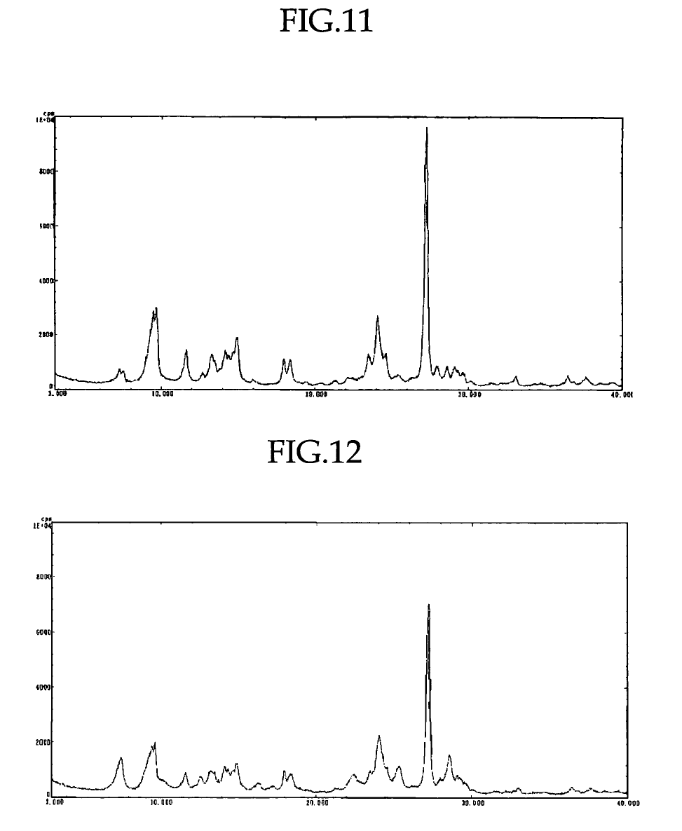

To the pigment (lowest angle: 7.3°) obtained in Synthesis Example 1 was added 3 wt. % of a pigment (having the maximum diffraction peak at 7.5°) prepared in a similar manner to that described in Japanese Patent Application Laid-Open (JP-A) No. 61-239248, followed by mixing in a mortar. The X-ray diffraction spectrum of the mixture was measured as described above. The X-ray diffraction spectrum of the Measurement Example 1 is shown in FIG. 11.

### Measurement Example 2

To the pigment (lowest angle: 7.5°) obtained in Synthesis Example 9 was added 3 wt. % of a pigment (having the maximum diffraction peak at 7.5°) prepared in a similar manner to that described in Japanese Patent Application Laid-Open (JP-A) No. 61-239248, followed by mixing in a mortar. The X-ray diffraction spectrum of the mixture was measured as described above. The X-ray diffraction spectrum of the Measurement Example 2 is shown in FIG. 12.

In the spectrum of FIG. 11, two independent peaks exist at 7.3° and 7.5° on the low angle side, suggesting that at least the peak of 7.3° and that of 7.5° are different. On the other hand, in the spectrum of FIG. 12, the peak on the low angle side exists only at 7.5°, suggesting that the spectrum is utterly different from that of FIG. 11.

From the above-described finding, the lowest angle peak 7.3° of the titanyl phthalocyanine crystals in the present invention is different from the peak 7.5° in the known titanyl phthalocyanine crystals.

As described above specifically in detail, the present invention provides an electrophotographic apparatus capable of outputting a highly precise image at a high speed, and capable of outputting a stable image free of line thickening even after repeated use at high speed.

More specifically, provided is an electrophotographic apparatus which has overcome the deterioration or instability of a light source even if writing is conducted at a resolution of 600 dpi or greater and having a highly stable surface potential (exposed portion, unexposed portion) of a photoconductor. Even if a non-halogen solvent is used for a charge transport layer coating solution, the electrophotographic apparatus provided by the invention can maintain a high sensitivity inherent to titanyl phthalocyanine.

What is claimed is:

1. An electrophotographic apparatus comprising:
an electrophotographic photoconductor;
a charger for charging the electrophotographic photoconductor;
a light irradiator for irradiating a white light to the electrophotographic photoconductor charged by the charger, thereby forming a latent electrostatic image;
a developer for feeding a developing agent to the latent electrostatic image, thereby visualizing the latent electrostatic image to form a toner image; and
a transfer for transferring the toner image formed by the developer onto a transfer material, wherein
a surface of the electrophotographic photoconductor exposed by the light irradiator requires 200 msec or less to reach the developer,
an exposure energy when the write light having a resolution of 600 dpi or greater is irradiated from the light irradiator to the electrophotographic photoconductor is 5 erg/cm² or less on the surface thereof,
the electrophotographic photoconductor is obtained by stacking at least a charge generation layer and a charge transport layer in this order on a conductive support, and
the charge generation layer contains titanyl phthalocyanine crystals having, as a diffraction peak (±0.2°) of Bragg angle 2θ with respect to CuKα ray (wavelength: 1.542 angstrom), a maximum diffraction peak at least at 27.2°, main peaks at 9.4°, 9.6° and 24.0°, and a peak at 7.3° as a diffraction peak on the lowest angle side, and not having a peak within a range of from 7.4° to 9.3°.

2. An electrophotographic apparatus according to claim 1, wherein the titanyl phthalocyanine crystals have not a peak at 26.3°.

3. An electrophotographic apparatus according to claim 1, wherein the titanyl phthalocyanine crystals have an average primary particle diameter less than 0.3 μm.

4. An electrophotographic apparatus according to claim 1, wherein the charge transport layer contains at least a polycarbonate having, on the main chain and/or side chain thereof, a triarylamine structure.

5. An electrophotographic apparatus according to claim 1, further comprising a protective layer on the charge transport layer.

6. An electrophotographic apparatus according to claim 5, wherein the protective layer contains one of an inorganic pigment and a metal oxide having a specific resistance of 10¹⁰ Ω·cm or greater.

7. An electrophotographic apparatus according to claim 1, wherein the charge transport layer of the electrophotographic photoconductor has been formed using a non-halogen solvent.

8. An electrophotographic apparatus according to claim 7, wherein at least one solvent selected from cyclic ethers and aromatic hydrocarbons is used as the non-halogen solvent.

9. An electrophotographic apparatus according to claim 1, wherein the conductive support of the electrophotographic photoconductor has an anodized surface.

10. An electrophotographic apparatus according to claim 1, wherein a plurality of image forming elements each having at least a charger, a light irradiator, a developer, a transfer and an electrophotographic photoconductor have been arranged.

11. An electrophotographic apparatus according to claim 1, wherein as the charger of the electrophotographic apparatus, a contact charging system is employed.

12. An electrophotographic apparatus according to claim 1, wherein as the charger of the electrophotographic apparatus, a non-contact proximal charging system is employed.

13. An electrophotographic apparatus according to claim 12, wherein a gap between a charging member for the charger and the electrophotographic photoconductor is 200 μm or less.

14. An electrophotographic apparatus according to claim 1, wherein alternating superposed voltage is applied to the charger of the electrophotographic apparatus.

15. An electrophotographic apparatus according to claim 1, wherein the electrophotographic apparatus may have, installed thereon, a freely detachable process cartridge in which an electrophotographic photoconductor has been formed integral with at least one unit selected from a charger, light irradiator, developer and cleaner.

16. An electrophotographic apparatus according to claim 1, wherein the write light is irradiated from the light irradiator at a resolution of 600 dpi or greater.

17. A process cartridge used as a detachable member and formed integral with an electrophotographic apparatus comprising:
an electrophotographic photoconductor;
a charger for charging the electrophotographic photoconductor;
a light irradiator for irradiating a write light to the electrophotographic photoconductor charged by the charger, thereby forming a latent electrostatic image;
a developer for feeding a developing agent to the latent electrostatic image, thereby visualizing the latent electrostatic image to form a toner image; and
a transfer for transferring the toner image formed by the developer onto a transfer material, wherein a surface of the electrophotographic photoconductor exposed by the light irradiator requires 200 msec or less to reach the developer, and an exposure energy when the write light having a resolution of 600 dpi or greater is irradiated from the light irradiator to the electrophotographic photoconductor is 5 erg/cm² or less on the surface thereof, which process cartridge comprises:
an electrophotographic photoconductor and at least one unit selected from a charger, a light irradiator, a developer and a cleaner,
said electrophotographic photoconductor being obtained by stacking at least a charge generation layer and a charge transport layer in this order on a conductive support, and containing, in the charge generation layer, titanyl phthalocyanine crystals having, as a diffraction peak (±0.2°) of Bragg angle 2θ with respect to CuKα ray (wavelength: 1.542 angstrom), a maximum diffraction peak at least at 27.2°, main peaks at 9.4°, 9.6° and 24.0°, and a peak at 7.3° as a diffraction peak on the lowest angle side, and not having a peak within a range of from 7.4° to 9.3°.

18. A process cartridge for electrophotographic apparatus according to claim 17, wherein the write light is irradiated from the light irradiator at a resolution of 600 dpi or greater.

19. An image forming method comprising:
charging an electrophotographic photoconductor;
irradiating a write light to the electrophotographic photoconductor charged by the charger, thereby forming a latent electrostatic image;
developing by feeding a developing agent to the latent electrostatic image to visualize the latent electrostatic image into a toner image; and
transferring the toner image developed in the developing step onto a transfer material, wherein:
a surface of the electrophotographic photoconductor exposed in the exposing step requires 200 msec or less to reach the developing step,
a write light having a resolution of 600 dpi or greater is irradiated from a light irradiator to the electrophotographic photoconductor so that an exposure energy will become 5 erg/cm² or less on the surface thereof in the exposing step,
said electrophotographic photoconductor is obtained by stacking at least a charge generation layer and a charge transport layer in this order on a conductive support, and
said charge generation layer contains titanyl phthalocyanine crystals having, as a diffraction peak (±0.2°) of Bragg angle 2θ with respect to CuKα ray (wavelength: 1.542 angstrom), a maximum diffraction peak at least at 27.2°, main peaks at 9.4°, 9.6° and 24.0°, and a peak at 7.3° as a diffraction peak on the lowest angle side, and not having a peak within a range of from 7.4° to 9.3°.

20. An image forming method according to claim 19, wherein the titanyl phthalocyanine crystals have not a peak at 26.3°.
